(19) United States
(12) Patent Application Publication
(10) Pub. No.: US 2026/0093125 A1
(43) Pub. Date: Apr. 2, 2026

(54) RETICLE FOR A VIEWING OPTIC AND METHOD OF USE

(71) Applicant: DIMITRI MIKROULIS, HENDERSON, NV (US)

(72) Inventor: DIMITRI MIKROULIS, HENDERSON, NV (US)

(21) Appl. No.: 19/346,287

(22) Filed: Sep. 30, 2025

Related U.S. Application Data
(60) Provisional application No. 63/702,623, filed on Oct. 2, 2024.

(51) Int. Cl. G02B 27/32; F41G 1/38; F41G 1/473; F41G 11/00

(52) U.S. Cl. CPC G02B 27/32; F41G 1/38; F41G 1/473; F41G 11/00

(57) ABSTRACT

The disclosure is directed to a reticle for a viewing optic including marks defining sets of lower and upper ranging points configured to auto-range targets at predetermined distances according to selected ranging dimensions and target reference points.

### CROSS-REFERENCE TO RELATED APPLICATIONS

This application claims benefit of U.S. Provisional Patent Application No. 63/702,623, filed on Oct. 2, 2024, the content of which is hereby incorporated by reference in its entirety.

### BACKGROUND OF THE DISCLOSURE

### 1. Field of the Disclosure

This disclosure relates generally in the field of reticles for viewing optics.

### 2. Background Art

Reticles used for auto-ranging typically include marks configured to range a target of known ranging dimension at one or more distances from the reticle, based on selected target reference points corresponding to that ranging dimension. Efficiently augmenting the variety of predetermined targets and ranging dimensions that may be auto-ranged by a reticle is desirable.

### SUMMARY OF THE DISCLOSURE

The disclosure provides a reticle for a viewing optic configured to auto-range one or more target objects at a plurality of predetermined distances from the reticle according to selected ranging dimensions.

The disclosure also provides a reticle for a viewing optic, the reticle comprising a plurality of marks with points combinable into sets of lower and upper ranging points for auto-ranging a plurality of targets at predetermined distances from the reticle; wherein each set of lower and upper ranging points is configured to auto-range one or more targets of the plurality of targets based on a ranging dimension using selected target reference points corresponding to the ranging dimension; wherein at least two of the sets of lower and upper ranging points share at least one common lower ranging point; and wherein at least two of the sets of lower and upper ranging points share at least one common upper ranging point.

### BRIEF DESCRIPTION OF THE SEVERAL VIEWS OF THE DRAWING

FIG. 1 is a plan view of an embodiment of a reticle of the present disclosure.

FIG. 2 is a plan view of the reticle of FIG. 1 set within a demonstrative sight picture.

FIG. 3 is another plan view of the reticle of FIG. 1.

FIG. 4 is another plan view of the reticle of FIG. 1.

FIG. 5 is a plan view of another embodiment of a reticle of the present disclosure.

FIG. 6 is a plan view of another embodiment of a reticle of the present disclosure.

FIG. 7 is a plan view of another embodiment of a reticle of the present disclosure.

FIG. 8 is another plan view of the reticle of FIG. 1.

FIG. 9 is another plan view of the reticle of FIG. 1.

FIG. 10 is another plan view of the reticle of FIG. 1.

FIG. 11 is another plan view of the reticle of FIG. 1.

FIG. 12 is another plan view of the reticle of FIG. 1.

FIG. 13 is another plan view of the reticle of FIG. 1.

FIG. 14 is a plan view of the reticle of FIG. 1 illustrating vertical auto-ranging of a target shown as a white-tailed deer.

FIG. 15 is a plan view of the reticle of FIG. 1 illustrating vertical auto-ranging of a target shown as a mule deer.

FIG. 16 is a plan view of the reticle of FIG. 1 illustrating vertical auto-ranging of a target shown as an elk.

FIG. 17 is a plan view of the reticle of FIG. 1 illustrating vertical auto-ranging of a target shown as a moose.

FIG. 18 is a plan view of the reticle of FIG. 1 illustrating vertical auto-ranging of a target shown as a coyote.

FIG. 19 is a plan view of the reticle of FIG. 1 illustrating vertical auto-ranging of a target shown as a coyote.

FIG. 20 is a plan view of the reticle of FIG. 1 illustrating vertical auto-ranging of a target shown as an American red fox.

FIG. 21 is a plan view of the reticle of FIG. 1 illustrating horizontal range estimation of a spherical target shown as a basketball.

FIG. 22 is a plan view of another embodiment of a reticle of the present disclosure.

FIG. 23 is an enlarged partial plan view of the reticle of FIG. 22.

FIG. 24 is another enlarged partial plan view of the reticle of FIG. 22.

FIG. 25 is another enlarged partial plan view of the reticle of FIG. 22.

FIG. 26 is another enlarged partial plan view of the reticle of FIG. 22 shown aimed at a target shown as a white-tailed deer.

FIG. 27 is a plan view of the reticle of FIG. 1 illustrating vertical auto-ranging of a target shown as a white-tailed deer.

### DEFINITIONS USED IN THE DISCLOSURE

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” or “essentially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

The term “and/or” includes any and all combinations of one or more of the associated listed items.

### DETAILED DESCRIPTION OF THE DISCLOSURE

For the purposes of promoting an understanding of the principles of the disclosure, reference is now made to the embodiments illustrated in the drawings and particular language will be used to describe the same. It is understood that no limitation of the scope of the claimed subject matter is intended by way of the present disclosure.

The terms “first,” “second,” “third,” and the like, herein do not denote any order, quantity, or importance, but rather are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be.”

In regard to the use of a term in this disclosure in the singular and/or plural, persons of ordinary skill in the art can translate such term(s) from the singular to the plural and/or from the plural to the singular in accordance with the context of the disclosure. The inclusion of “(s)” after an element or a step indicates that one or more than one of such element or step is present with the understanding that each thereof is an independent aspect of the disclosure. As used herein, the term “skilled artisan” refers to a person of ordinary skill in the art.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like. The use of the term “assembly” does not imply that the components or functionality described or claimed as part of an assembly are all necessarily configured in a common package.

It is to be understood that the present disclosure is not limited to particular embodiments. The terminology used herein is for the purpose of describing particular embodiments only, and is not intended to be limiting. As used in this specification and the appended claims, a “projectile launching device” includes, without limitation, firearms, bows, and crossbows. Herein, the term “firearm” includes, without limitation, pistols, rifles (e.g., semiautomatic or bolt-action), shotguns, revolvers, air rifles, and paintball guns, among other projectile-firing devices. As understood by a person skilled artisan skilled in the art of firearms and/or firearm shooting (the “skilled artisan”), a particular firearm may be provided in different barrel lengths. Non-limiting examples of pistols are provided in U.S. Pat. No. 4,539,889, titled “Automatic Pistol with Counteracting Spring Control Mechanism,” issued on Sep. 10, 1985; and U.S. Pat. No. D918,328 S, titled “Handgun,” issued on May 4, 2021, each of which is herein incorporated by reference in its entirety. Non-limiting examples of semiautomatic rifles are provided in U.S. Pat. No. 9,777,975 B2, titled “Semiautomatic Firearm,” issued on Oct. 3, 2017; and U.S. Pat. No. 7,775,150 B2, titled “Law Enforcement Carbine with One Piece Receiver,” issued on Aug. 17, 2010, each of which is herein incorporated by reference in its entirety. Non-limiting examples of a bolt action firearm are provided in U.S. Pat. No. 8,925,234 B1, titled “Bolt Action Rifle with Safety Latching Mechanism,” issued on Jan. 6, 2015; and U.S. Pat. No. 8,397,416 B2, titled “Multi-Caliber Bolt-Action Rifle and Components,” issued on Mar. 19, 2013; each of which is herein incorporated by reference in its entirety.

Herein, the term “viewing optic” refers to, without limitation, binoculars, portable telescopes (e.g., monoculars, spotting scopes), and optical sights. The term “optical sight” may be used interchangeably with the terms “scope,” “scope sight,” and “telescopic sight.” When configured for mounting on a rifle, an optical sight may also be referred to as a riflescope or a riflescope sight. When configured for mounting on a pistol, an optical sight may also be referred to as a pistol scope or pistol scope sight. Herein, a person using a reticle of a viewing optic of this disclosure may be referred to as a “user” and/or “operator” Herein, a person using a reticle of a viewing optic and a corresponding projectile launching device may also be referred to as a “shooter.” An optical sight may include a first focal plane optical sight, a second focal plane optical sight, or a dual focal plane optical sight. Non-limiting examples of monoculars are described in U.S. Pat. No. 5,943,174, titled “Night Vision Monocular Device,” issued on Aug. 24, 1999; and U.S. Pat. No. 7,397,617 B2, titled “Collimated Optical System,” issued on Jul. 8, 2008, each of which is herein incorporated by reference in its entirety. Non-limiting examples of spotting scopes are described in U.S. Pat. No. 9,335,536 B2, titled “Visual Target Acquisition Scope System,” issued on May 10, 2016; U.S. Pat. No. 4,669,833, titled “Spotting Scope with Alignment Viewer,” issued on Jun. 2, 1987; and U.S. Pat. No. 8,196,828 B2, titled “Assisted Sighting System for Snipers.” issued on Jun. 12, 2012, each of which is herein incorporated by reference in its entirety. Non-limiting examples of binoculars are described in U.S. Pat. No. 5,777,785, titled “Binoculars,” issued on Jul. 7, 1998; U.S. Pat. No. 5,235,458, titled “Binocular,” issued on Aug. 10, 1993, each of which is herein incorporated by reference in its entirety. Non-limiting examples of firearm optical sights are described in U.S. Pat. No. 4,806,007, titled “Optical Gun Sight.” issued on Feb. 21, 1989; U.S. Pat. No. 7,676,137 B2, titled “Optical Sight,” issued on Mar. 9, 2010; U.S. Pat. No. 4,576,451, titled “Aiming Telescope,” issued on Mar. 18, 1986; U.S. Pat. No. 11,473,873 B2, titled “Viewing Optic with Round Counter System,” issued on Oct. 18, 2022; U.S. Pat. No. 9,970,735 B2, titled “Telescopic Sight,” issued on May 15, 2018, each of which is herein incorporated by reference in its entirety.

Herein, a “target object” refers to one or more objects, which may be animate or inanimate. Animate objects may include, without limitation, human beings, animals, or combinations thereof, having various dimensions, including, but not limited to selected widths and/or heights corresponding to known sizes and/or profiles. Inanimate objects may also have various dimensions, including, but not limited to selected widths and/or heights and/or profiles.

For purposes of this disclosure, a human being target object may, in certain implementations, be referred to as an “enemy combatant,” for example in military, law enforcement, gaming, and training scenarios. An animal target object may include, without limitation, one or more bipedal organisms (“bipeds”) i.e., animals that use two weight-bearing limbs for locomotion (e.g., walking, running, hopping, skipping), and/or one or more quadrupedal organisms (“quadrupeds”) i.e., animals that use four weight-bearing limbs for locomotion (e.g., walking, ambling, pacing, trotting, cantering, galloping). Non-limiting examples of quadrupeds include, but are not limited to, members of the Cervidae family, members of the Canidae family, members of the Bovidae family, members of the Suidae family, members of the Ursidae family, members of the Felidae family, and member of the Antilocapridae family (e.g., pronghorn).

In an embodiment, a biped may also refer to a humanoid or animaloid machine, robot, or combinations thereof. In an embodiment, a quadruped may also refer to a humanoid or animaloid machine, robot, or combinations thereof. Non-limiting examples of inanimate objects may include, bullseye targets, silhouette targets, reactive targets (e.g., steel plates), paper targets providing one or more profiles (e.g., bullseyes, geometric shapes, silhouettes, photographic images, raster images, illustrations).

As used herein, “shape type” refers to a generalized structural configuration or silhouette associated with a target object or group of target objects. Shape type may include, without limitation, bipedal or quadrupedal forms, and geometric, anatomical, or representational forms for inanimate targets, including those that simulate animals or humans. For example, a quadrupedal shape type includes four weight-bearing limbs, head-forward posture, tail at rear, and horizontal body orientation.

As understood by persons of ordinary skill in the art of firearm target shooting, exemplary inanimate objects may include three-dimensional or silhouette targets representing humans or animals, at full scale or partial scale. Human inanimate targets may include a torso, upper body, or full body including the head. Animal inanimate targets may include an entire animal or a portion thereof. Three-dimensional inanimate animal targets may include broadside, quartering toward, or quartering away orientations relative to the reticle of a viewing optic. Silhouette targets for humans or animals may also be represented in broadside, quartering toward, or quartering away orientations relative to the reticle of a viewing optic, similar to three-dimensional targets. Animal inanimate targets, whether three-dimensional or silhouette, may include one or more markings identifying particular anatomy and/or vital organs. For purposes of this disclosure, the terms “target object” and “target” may be used interchangeably. As used herein, a “selected target reference point” refers to any point or feature of a target, whether anatomical, structural, geometric, or otherwise, that is chosen for use in auto-ranging.

As understood by the skilled artisan, the term “back,” when used as an anatomical point of a quadruped, refers to the spine region as illustrated herein. The “belly area” or “belly” of a quadruped refers to the ventral abdominal underside of the torso, opposite the back as illustrated herein. Regarding animals such as bipeds and quadrupeds, the term “support limb distal portion” refers to the portion of a limb that contacts the ground during locomotion or supports the weight of the animal, including but not limited to, feet, paws, hooves, claws, toes, or other terminal structures.

Regarding a reticle of this disclosure, a distance to a target refers to a distance from a reticle of a viewing optic to the target. As such, phrases such as “at a distance of 300.0 yards” and “a range of 300.0 yards” refer to a distance from a target to the reticle of a viewing optic.

Herein, the phrase “field of view” (“FOV”) refers to the visible or observable area through an optical element of a viewing optic as observed by a user or operator (e.g., a shooter), at a particular distance between the operator's eye(s) and the optical element. As understood by a person of ordinary skill in the art, often the larger a lens of a viewing optic the larger the field of view of the viewing optic at a particular distance between the operator's eye(s) and the optical element.

The term “mark” is used herein to define one or more indicia of a reticle. Marks of this disclosure may comprise one or more indicia of one or more shapes or configurations including, but not limited to dots, straight lines, curved lines, closed circles, open circles, closed rings, open rings, triangles, stars, chevrons, bullseyes, diamonds, X-shapes, “T” shapes, crosses, letters, numbers, are shapes, solid shapes and silhouette shapes including irregular shapes, and combinations thereof. Herein, a “dot” need not be circular or substantially circular.

Herein “mph” refers to miles per hour and “mps” refers to meters per second. Herein, “km/h” refers to kilometers per hour and “ft/s” refers to feet per second. The phrase “time on target” refers to the time required for an operator of a projectile launching device (e.g., a firearm user or shooter), to realize the aiming point of a given round to a particular target in real time, i.e., the time required for target acquisition. Herein, rapid or fast time on target is a time of or about 3.0 seconds or less. The terms “automatic” and “auto” may be used interchangeably. The terms “auto-range,” “auto-ranging,” and like terms, refer to the ability to distance range or distance range estimate one or more targets with a reticle of the present disclosure without making or using distance range calculations. The term “auto leading,” and like terms, refers to the ability to lead one or more targets with a reticle of the present disclosure without making or using lead calculations. The term “auto bullet drop compensation,” and like terms, refers to the ability to identify how far a bullet drops over a given distance without making or using bullet drop calculations. Herein, the act of aiming at a target refers to using a reticle of this disclosure to aim a firearm or other projectile launching device at a target.

Herein, the term “bullet drop” refers to the downward deviation of a projectile's trajectory, relative to its initial line of travel, as the projectile moves over a distance (“target range” or “target distance”) from a projectile launching device to a target. As understood by those skilled in the art, bullet drop results from the effect of gravity acting on the moving projectile. Accordingly, at longer ranges it is typically necessary to adjust the aiming point (e.g., by elevating the barrel of a firearm or using reticle marks) to compensate for bullet drop. Herein, the term “full value wind” refers to wind blowing perpendicular (left-to-right or right-to-left) relative to a reticle and its user, i.e., a crosswind. Using the standard clock system, full value winds correspond to winds traveling from “9 to 3” or from “3 to 9.” As understood by those skilled in the art, a full value wind exerts the maximum lateral effect on the flight of a bullet, in contrast to a “half value wind” (e.g., diagonal) or a ‘no value wind’ (headwind or tailwind). Generally, the greater the wind velocity, the greater its corresponding effect on bullet trajectory.

Herein, the terms “MIL” or “MRAD” are abbreviations for “milliradian” and the plural forms “MILs” and “MRADs” denote milliradians. A milliradian is an angular measurement equal to one-thousandth of a radian. There are 6.283 radians in a circle, which equates to 6283.0 milliradians in a circle. As understood by those skilled in the art, milliradians are commonly used in adjustment of firearm sights, wherein the angle of the sight is adjusted relative to the barrel of the corresponding firearm. For purposes of this disclosure, the terms “milliradian,” “MIL.” and “MRAD” may be used interchangeably.

Herein, the term “MOA” (Minute of Angle) refers to an angular measurement, wherein one MOA equals 1/60 of a degree. At a distance of 100.0 yards, 1.0 MOA subtends approximately 1.047 inches (commonly approximated as 1.0 inch). As understood by the skilled artisan, “subtension” refers to the portion of a target covered by an element of a reticle, and may be expressed either as a linear measure at a given distance (e.g., inches at 100.0 yards) or as an angular measure in MRAD or MOA. In the context of this disclosure, the term “subtension mark” (also referred to as an “angular measurement subtension mark”) denotes one or more indicia on a reticle, such as MRAD or MOA subtension marks.

In firearm shooting and other projectile targeting activities, it is understood that distances in meters may be converted to yards and vice versa. A non-limiting sampling of conversions for various distances in meters and yards are provided in Tables 1 and 2 below.

TABLE 1

| Distance (in meters) | Distance (in yards) |
|---|---|
| 50.0 | 54.68 |
| 100.0 | 109.36 |
| 150.0 | 164.04 |
| 200.0 | 218.72 |
| 250.0 | 273.40 |
| 300.0 | 328.08 |
| 350.0 | 382.77 |
| 400.0 | 437.45 |
| 450.0 | 492.13 |
| 500.0 | 546.81 |
| 550.0 | 601.49 |
| 600.0 | 656.17 |

TABLE 2

| Distance (in yards) | Distance (in meters) |
|---|---|
| 50.0 | 45.72 |
| 100.0 | 91.44 |
| 150.0 | 137.16 |
| 200.0 | 182.88 |
| 250.0 | 228.6 |
| 300.0 | 274.32 |
| 350.0 | 320.04 |
| 400.0 | 365.76 |
| 450.0 | 411.48 |
| 500.0 | 457.2 |
| 550.0 | 502.92 |
| 600.0 | 548.64 |

As understood by the skilled artisan, 1.0 MRAD at 100.0 yards equals 9.14 cm (3.6 inches), 1.0 MRAD at 200.0 yards equals 18.29 cm (7.2 inches) and so forth as described in Table 3 below out to a distance of 600.0 yards. Likewise, 1.0 MRAD at 100.0 meters equals 10.0 cm and so forth as described in Table 4 below out to a distance of 600.0 meters.

TABLE 3

| Range (in yards) | One MRAD (in cm) | One MRAD (in inches) |
|---|---|---|
| 100.0 | 9.14 | 3.6 |
| 200.0 | 18.29 | 7.2 |
| 300.0 | 27.43 | 10.8 |
| 400.0 | 36.58 | 14.4 |
| 500.0 | 45.72 | 18.0 |
| 600.0 | 54.86 | 21.6 |

TABLE 4

| Range (in meters) | One MRAD (in cm) | One MRAD (in inches) |
|---|---|---|
| 100.0 | 10.00 | 3.94 |
| 200.0 | 20.00 | 7.87 |
| 300.0 | 30.00 | 11.81 |
| 400.0 | 40.00 | 15.75 |
| 500.0 | 50.00 | 19.69 |
| 600.0 | 60.00 | 23.62 |

As understood by those skilled in the art, the phrase “30 caliber cartridge” may refer to, without limitation, cartridges such as the .308 Winchester (“.308”), the .30-30 Winchester, the 7.62×51 mm NATO, the .30/06 Springfield, and the .30 Carbine. It is further understood that while the .308 Winchester and the 7.62×51 mm NATO cartridges are not identical (the .308 Winchester typically being loaded to a higher pressure), the two are generally regarded as sufficiently similar in dimensions that, in practice, firearms chambered for one are often capable of chambering the other.

Herein, the term .300 Winchester Magnum (also “.300 Win Mag” or “300 WM”) refer to the 7.62×67 mm cartridge or round. The terms “5.45” and “5.45 round” refer to the 5.45×39 mm cartridge. Herein, the term “7.62 NATO” refers to the 7.62×51 mm cartridge. The term “7.62 Soviet” refers to the 7.62×39 mm cartridge. The term “6.5 Creedmoor” refers to 6.5×48 mm cartridge. The terms “6.5 Grendel” and “6.5 mm Grendel” refer to the 6.5×39 mm cartridge. The term “6 mm Advanced Rifle Cartridge” (or “6 mm ARC”) refers to the 6.0×38 mm cartridge.

Herein, the terms “5.56” and “5.56 round” refer to the 5.56×45 mm NATO cartridge (military designation). Likewise, the terms “.223” and “.223 round” refer to the .223 Remington cartridge. As understood by those skilled in the art, while the 5.56×45 mm NATO and .223 Remington cartridges are not dimensionally or performance-wise identical, the terms are sometimes used interchangeably in common usage.

The terms “M855” and “M855 round” refer to a 5.56×45 mm NATO cartridge comprising a gilding, metal-jacketed, lead alloy core bullet with a steel penetrator. The term “MK 262” refers to a 5.56×45 mm NATO cartridge commercially available from Black Hills Ammunition, Rapid City, South Dakota, U.S.A. The term “M193” refers to a 5.56×45 mm NATO cartridge comprising a 55-grain, gilded metal-jacketed, lead alloy core bullet. The term “.50 Browning” or “Browning .50 caliber” refers to the 12.7×99 mm NATO cartridge.

As understood by the skilled artisan, .223 Remington and 5.56×45 mm NATO cartridges are commonly used in AR-15 type rifle platforms, including military variants such as the M16 rifle and the M4 Carbine, the latter being a shortened variant of the M16. The term “M27” refers to the M27 Infantry Automatic Rifle, a 5.56 mm firearm derived from the HK416 platform produced by Heckler & Koch GmbH, Oberndorf, Germany.

Herein, the term “cartridge” refers to a self-contained package for a firearm, comprising a bullet, casing, propellant, and primer. The terms “cartridge” and “round” may be used interchangeably. The term “ammunition” refers to one or more cartridges, and the terms “ammunition” and “ammo” may be used interchangeably. A combination of a particular cartridge and a firearm chambered for that cartridge may be referred to as a “firearm/ammo combination.”

In an embodiment, a reticle of this disclosure may be located on a transparent member of a viewing optic such as a transparent plastic, crystal, fused silica, or glass. In an embodiment, a reticle of this disclosure may be chemically or physically etched onto a transparent member as understood by the skilled artisan.

In an embodiment, the disclosure relates to a reticle for a viewing optic configured to vertically auto-range a plurality of targets at a plurality of predetermined distances from the reticle. In an embodiment, the disclosure relates to a reticle of a viewing optic configured to vertically auto-range a plurality of bipeds and/or quadrupeds at a plurality of predetermined distances from the reticle.

In an embodiment, the disclosure relates to a reticle for a viewing optic, the reticle comprising marks configured to auto-range a plurality of targets at a plurality of predetermined distances from the reticle according to a selected ranging dimension for each target (or “target ranging dimension;” “selected target ranging dimension”). In an embodiment, the marks may be provided as a ranging scale or the like.

In an embodiment, the disclosure relates to a reticle for a viewing optic, the reticle comprising marks configured to vertically auto-range a plurality of targets at a plurality of predetermined distances from the reticle. The marks include a plurality of lower and upper vertical ranging points, which are configured to vertically auto-range select targets based on vertical ranging dimensions at the plurality of predetermined distances from the reticle. In an embodiment, some ranging points are configured as lower vertical ranging points for targets of dissimilar vertical ranging dimensions, some ranging points are configured as upper vertical ranging points for targets of dissimilar vertical ranging dimensions, and some ranging points are configured as both lower vertical ranging points and upper vertical ranging points.

In an embodiment, the disclosure relates to a reticle for a viewing optic, the reticle comprising a plurality of marks defining a plurality of points configured to vertically auto-range a plurality of targets at a plurality of predetermined distances from the reticle according to a selected vertical ranging dimension for each target, wherein each target is auto-ranged according to a lower selected target reference point and an upper selected target reference point defining the selected vertical ranging dimension of the target.

In an embodiment, the disclosure relates to a reticle for a viewing optic, the reticle comprising at least (1) one or more horizontal marks and (2) a plurality of vertical marks; wherein the one or more horizontal marks and the plurality of vertical marks are configured to vertically auto-range a plurality of targets of selected vertical ranging dimensions at a plurality of predetermined distances from the reticle.

In an embodiment, the disclosure relates to a reticle for a viewing optic, the reticle comprising at least (1) one or more horizontal marks, and (2) one or more vertical marks, wherein the one or more horizontal marks and the one or more vertical marks are configured to vertically auto-range one or more targets of one or more selected vertical ranging dimensions at one or more predetermined incremental distances from the reticle.

In an embodiment, the disclosure relates to a reticle for a viewing optic, the reticle comprising at least (1) one or more horizontal marks, and (2) a plurality of vertical marks, wherein the one or more horizontal marks and the plurality of vertical marks include points configured to vertically auto-range a plurality of targets at a plurality of predetermined distances from the reticle according to a selected vertical ranging dimension for each target, wherein each target is auto-ranged according to a lower selected anatomical target reference point and an upper selected anatomical target reference point defining the selected vertical ranging dimension for the target.

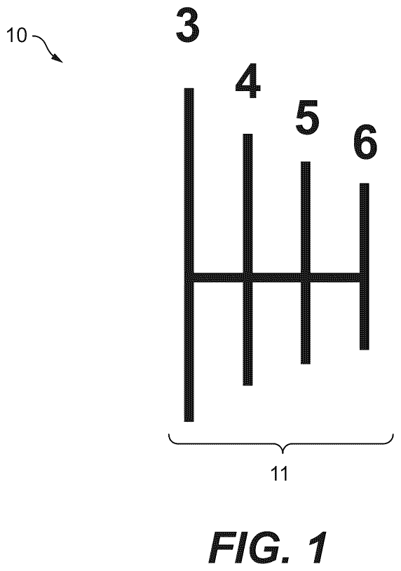

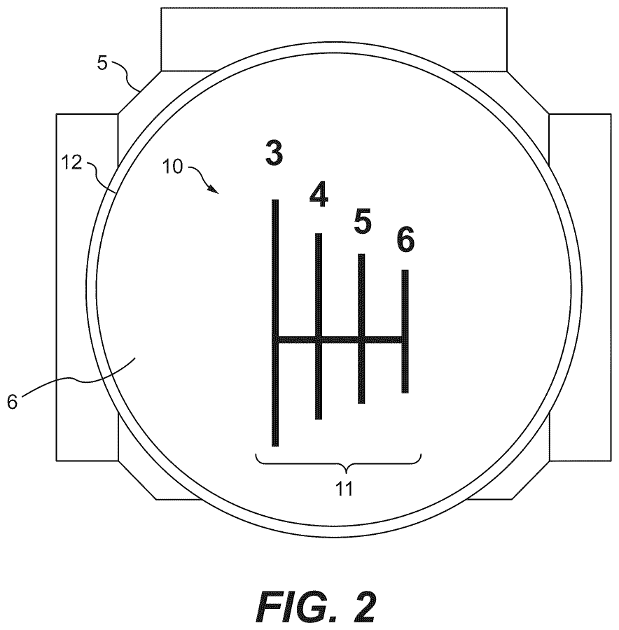

FIG. 1 illustrates an embodiment of a reticle 10 of the present disclosure, the reticle 10 comprising at least a ranging scale 11. When viewed through a viewing optic 5, the reticle 10 may appear as shown in FIG. 2, which illustrates the ranging scale 11 set at a centered position, or substantially centered position, at the optical axis of the viewing optic 5 within a demonstrative sight picture 12 of the viewing optic 5. In another embodiment, the ranging scale 11 may be viewed at an off-axis or off-center position, i.e., away from the optical axis of the viewing optic 5. As described herein, a ranging scale 11 of this disclosure may be configured to vertically auto-range a plurality of targets of known vertical ranging dimensions at predetermined distances from the ranging scale 11 using selected points on the ranging scale 11 to vertically auto-range each of the plurality of targets. In an embodiment, the ranging scale 11 may be configured to vertically auto-range a plurality of targets such as bipeds and/or quadrupeds at predetermined distances from the reticle 10, using selected points on the ranging scale 11 to auto-range each individual target biped and/or quadruped according to a lower selected anatomical target reference point and an upper selected anatomical target reference point defining a known vertical ranging dimension for the target. As shown in FIGS. 1 and 2, when the ranging scale 11 comprises the entirety of the reticle 10, then the reticle 10 may be considered configured to vertically auto-range a plurality of targets of known vertical ranging dimensions at predetermined distances from the reticle 10, using selected points on the reticle 10 to vertically auto-range each target as described herein.

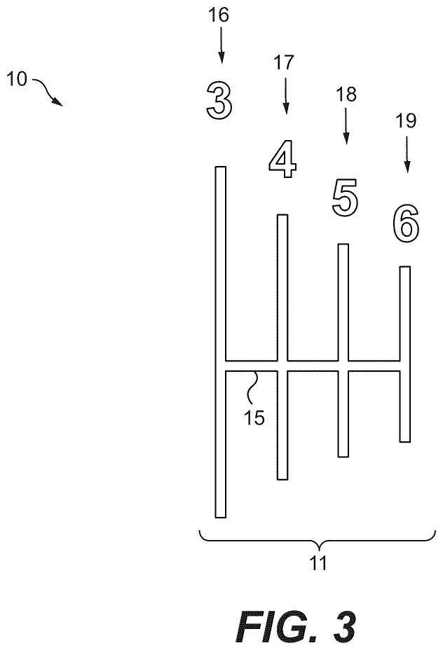

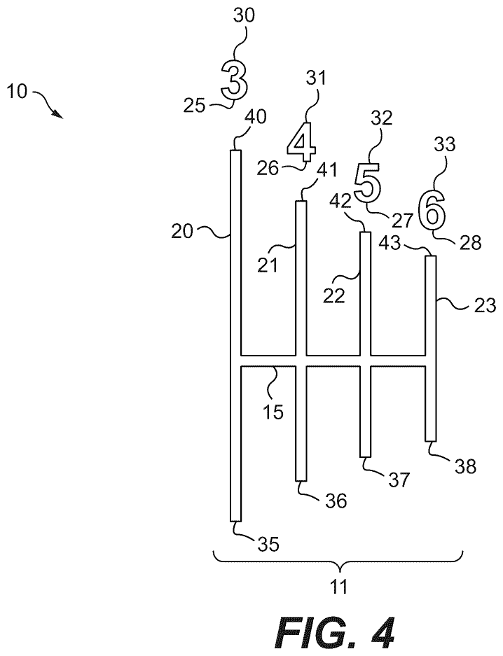

With reference to FIGS. 3 and 4, in an embodiment a reticle 10 may comprise a ranging scale 11 having one or more horizontally disposed ranging marks 15 comprising one or more indicia and a plurality of vertically disposed ranging marks 16, 17, 18, 19 comprising one or more indicia intersecting the one or more horizontally disposed ranging marks 15. In an embodiment, the one or more horizontally disposed ranging marks 15 may include at least one linear indicia or “horizontal crosshair 15” and each of the vertically disposed ranging marks 16, 17, 18, 19 may include (1) at least one upper mark comprising one or more indicia, and (2) at least one lower mark comprising one or more indicia, wherein each lower mark is located below and in linear alignment with a corresponding upper mark. As shown in FIG. 4, in an embodiment the lower marks of each of the vertically disposed ranging marks 16, 17, 18, 19 may include one or more linear marks operable as “vertical crosshairs 20, 21, 22, 23” intersecting the horizontal crosshair 15 at different points along the length of the horizontal crosshair 15. In an embodiment, the one or more indicia of the upper marks of each of the vertically disposed ranging marks 16, 17, 18, 19 may include at least a numeral indicium located above each of the vertical crosshairs 20, 21, 22, 23—see distance numeral “3” indicium located above vertical crosshair 20; see distance numeral “4” indicium located above vertical crosshair 21; see distance numeral “5” indicium located above vertical crosshair 22; and see distance numeral “6” indicium located above vertical crosshair 23. As described below, the numeral indicia of the upper marks may be configured, at least in part, as distance identifiers and may be referred to herein as “distance numerals.”

As further illustrated in FIG. 4, each of the distance numeral indicia has a bottommost edge (see bottommost edges 25, 26, 27, 28) and an uppermost edge (see uppermost edges 30, 31, 32, 33), wherein the uppermost edges 30, 31, 32, 33 define an upper end of each of the vertically disposed ranging marks 16, 17, 18, 19. Also, each of the vertical crosshairs 20, 21, 22, 23 includes a bottommost edge (see bottommost edges 35, 36, 37, 38) and an uppermost edge (see uppermost edges 40, 41, 42, 43), wherein the bottommost edges 35, 36, 37, 38 define a bottom end of each of the vertically disposed ranging marks 16, 17, 18, 19 as shown.

Still referring to FIGS. 3 and 4, in an embodiment the horizontal crosshair 15 and the vertical crosshairs 20, 21, 22, 23 may be provided as solid lines wherein the horizontal crosshair 15 comprises a length effective to form intersections for each of the vertical crosshairs 20, 21, 22, 23. In an embodiment, a horizontal crosshair 15 may be provided in a configuration different than as shown in FIGS. 3 and 4 whereby the horizontal crosshair 15 may extend out beyond one or both outermost vertical crosshairs a desired distance (e.g., extend out beyond the vertical crosshair 20 and/or vertical crosshair 23 a desired distance). Alternatively, the horizontal crosshair 15 may terminate short of one or both of the outermost vertical crosshairs (e.g., terminate short of the vertical crosshair 20 and/or vertical crosshair 23).

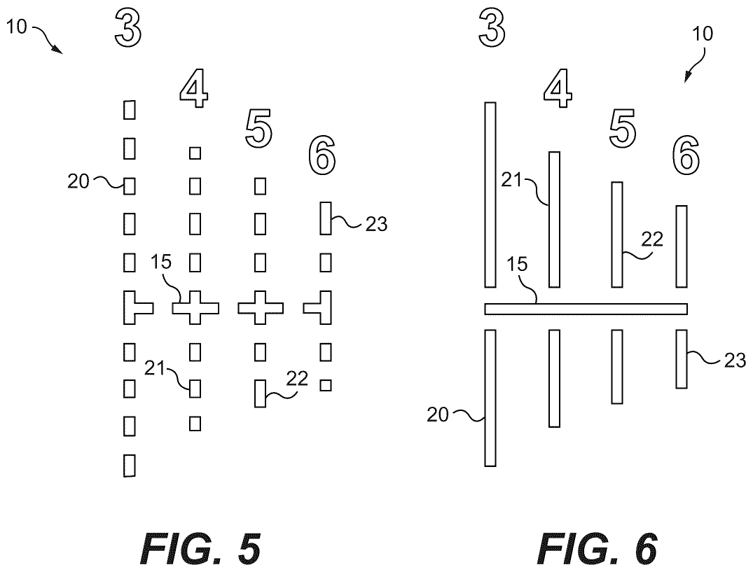

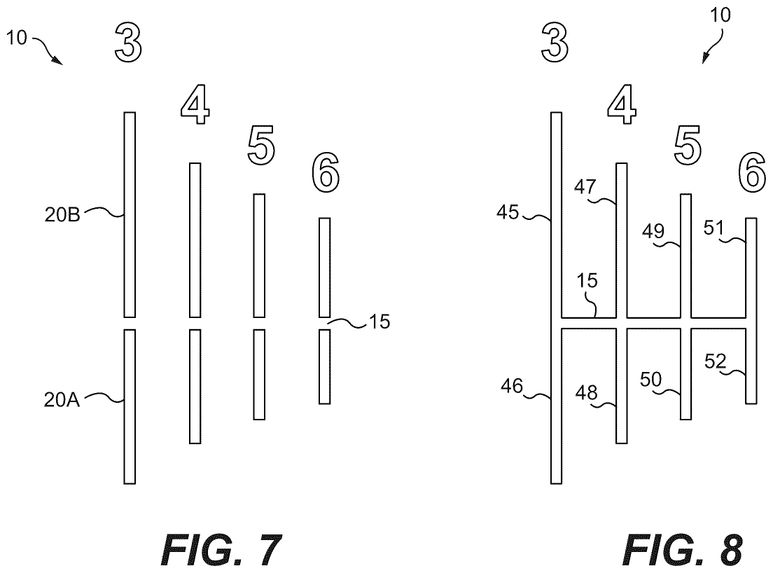

In an embodiment, one or more of the horizontal crosshair 15 and/or vertical crosshairs 20, 21, 22, 23 may be provided as a plurality of indicia including, but not limited to broken lines, and/or the like, as shown in FIG. 5. In an embodiment, one or more of the horizontal crosshair 15 and/or vertical crosshairs 20, 21, 22, 23 may be provided as solid lines, broken lines, dotted lines, other indicia as defined above, and combinations thereof. In an embodiment, one or more of the vertical crosshairs 20, 21, 22, 23 may be provided as a non-intersecting crosshair in relation to the horizontal crosshair 15 as shown in the non-limiting embodiment of FIG. 6. In an embodiment, each of the vertical crosshairs 20, 21, 22, 23 may be provided in the form of separate lower and upper crosshair segments, wherein the space or gap between the upper and lower crosshair segments defines a horizontal crosshair 15 (e.g., see lower segment 20A and upper segment 20B of vertical crosshair 20 defining part of horizontal crosshair 15 disposed there between as shown in FIG. 7).

In the embodiment of FIGS. 3 and 4, the distance numeral indicia are configured as visual indicators, each representing a vertical auto-ranging distance to a target for its vertically disposed ranging mark 16, 17, 18, 19. For example, in an embodiment the distance numeral “3” indicium of vertically disposed ranging mark 16 located above vertical crosshair 20 may represent a distance of 300.0 yards to a target. Likewise, the distance numeral “4” indicium located above vertical crosshair 21 may represent a distance of 400.0 yards to a target; the distance numeral “5” indicium located above vertical crosshair 22 may represent a distance of 500.0 yards to a target; and the distance numeral “6” indicium located above vertical crosshair 23 may represent a distance of 600.0 yards to a target. In an embodiment, distance numeral indicia of the vertically disposed ranging marks 16, 17, 18, 19 may represent distances in meters to a target (e.g., a distance numeral “3” indicium located above vertical crosshair 20 may represent a distance of 300.0 meters to a target).

In an embodiment, a ranging scale 11 may be provided with fewer distance numeral indicia than as depicted in FIGS. 3 and 4. In an embodiment, distance numeral indicia may be represented by actual distances. For example, the vertically disposed ranging mark 16 may include a distance numeral “300” indicium located above vertical crosshair 20 representing a distance of 300.0 yards or 300.0 meters to a target. Likewise, a distance numeral “400” indicium may be located above vertical crosshair 21 representing a distance of 400.0 yards or 400.0 meters to a target; a distance numeral “500” indicium may be located above vertical crosshair 22 representing a distance of 500.0 yards or 500.0 meters to a target; and a distance numeral “600” indicium may be located above vertical crosshair 23 representing a distance of 600.0 yards or 600.0 meters to a target. However, single digit distance numerals such as “3,” “4,” “5,” and “6” as shown may be desirable to minimize the visual footprint of indicia of the ranging scale 11, providing a cleaner field of view that maximizes visibility of objects through an optical medium of a viewing optic 5 beyond the reticle 10 indicia.

As shown in FIGS. 3 and 4, each of the vertically disposed ranging marks 16, 17, 18, 19, and each of the vertical crosshairs 20, 21, 22, 23, may have a different overall length. In the embodiment of FIGS. 3 and 4, the vertically disposed ranging marks 16, 17, 18, 19 and the vertical crosshairs 20, 21, 22, 23 are disposed in descending order whereby (1) ranging mark 16 is the longest ranging mark and vertical crosshair 20 is the longest vertical crosshair, and (2) ranging mark 19 is the shortest ranging mark and vertical crosshair 23 is the shortest vertical crosshair. In the embodiment of FIGS. 3 and 4, the horizontal crosshair 15 intersects each of the vertical crosshairs 20, 21, 22, 23 at a point dividing each of the vertical crosshairs 20, 21, 22, 23 into unequal or dissimilar length sections including (1) a longer upper vertical section disposed above the horizontal crosshair 15 and (2) a shorter lower vertical section disposed below the horizontal crosshair 15 (e.g., see upper vertical section 45 and lower vertical section 46 of vertical crosshair 20; upper vertical section 47 and lower vertical section 48 of vertical crosshair 21; upper vertical section 49 and lower vertical section 50 of vertical crosshair 22; and upper vertical section 51 and lower vertical section 52 of vertical crosshair 23 in FIG. 8).

Each vertical crosshair 20, 21, 22, 23 may be characterized by a width and positioned relative to one another at predetermined or selected spacings. In one non-limiting embodiment as shown in FIGS. 3 and 4, each of the vertical crosshairs 20, 21, 22, 23 may include a width of or about 1.38 MRAD (of or about 0.4 MOA) whereby the spacing orientation of the vertical crosshairs 20, 21, 22, 23 may define the length of the horizontal crosshair 15 (e.g., the length of the horizontal crosshair 15 may be determined by the separation between the leftmost vertical crosshair 20 and the rightmost vertical crosshair 23 as shown).

In an embodiment, the vertical crosshairs 20, 21, 22, 23 may be graduated in angular measurement increments. In one non-limiting embodiment, the vertical crosshairs 20, 21, 22, 23 may be spaced apart in 0.5 MRAD increments as measured at the midline of each vertical crosshair, such that the vertical crosshairs 20, 21, 22, 23 function as MRAD marks. In this configuration, the vertical crosshairs 20, 21, 22, 23 may be used for accurate horizontal range estimation of one or more targets of known dimensions, using calculation methods well known in the art of MRAD reticles. As understood by the skilled artisan, in range estimation operations using graduated marks, many shooters rely on reference field data books—commonly referred to as DOPE books (Data Obtained from Previous Engagements)—which contain potential target dimensions along with calculation and shooting adjustment information.

In an embodiment, a ranging scale 11 of this disclosure may include fewer vertically disposed ranging marks than the four ranging marks 16, 17, 18, 19 described above. For example, in an embodiment a ranging scale 11 may comprise only three vertically disposed ranging marks (e.g., ranging marks 16, 17, 18). In an embodiment, a ranging scale 11 may include one or more additional vertically disposed ranging marks in addition to the ranging marks 16, 17, 18, 19, with each additional ranging mark corresponding to an additional distance from the reticle 10 (e.g., a fifth ranging mark corresponding to a distance of 700.0 yards or 700.0 meters).

As stated above, a ranging scale 11 of this disclosure is configured to assist a user of the reticle 10 in auto-ranging a plurality of targets having known vertical ranging dimensions at a plurality of predetermined distances from the reticle 10. In an embodiment, a ranging scale 11 of a reticle 10 as shown in FIGS. 1-8, may be configured to provide auto-ranging of targets across one or more known vertical ranging dimensions, including, but not limited to, the following vertical ranging dimensions: (1) 35.56 cm (14.0 inches); (2) 45.72 cm (18.0 inches); (3) 55.88 cm (22.0 inches); (4) 81.28 cm (32.0 inches); and (5) 91.44 cm (36.0 inches).

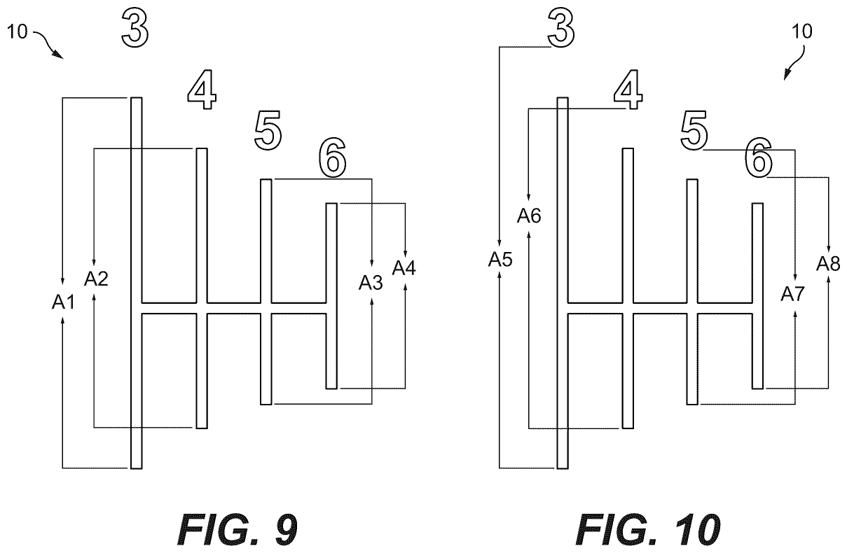

Referring to FIGS. 4 and 9, in an embodiment of a reticle 10, each of the vertically disposed ranging marks 16, 17, 18, 19 may include a lower ranging point and an upper ranging point configured to auto-range a vertical ranging dimension of or about 32.0 inches at selected distances, including, but not limited to, distances of or about 300.0 yards, 400.0 yards, 500.0 yards, and 600.0 yards from the reticle 10. In particular, ranging mark 16 may include a lower ranging point comprising the bottommost edge 35 of the vertical crosshair 20 and an upper ranging point comprising the uppermost edge 40 of vertical crosshair 20, defining a length corresponding to an angular measurement A1 configured to auto-range a vertical ranging dimension of or about 32.0 inches at a distance of or about 300.0 yards. Ranging mark 17 may include a lower ranging point comprising the bottommost edge 36 of the vertical crosshair 21 and an upper ranging point comprising the uppermost edge 41 of vertical crosshair 21, defining a length corresponding to an angular measurement A2 configured to auto-range a vertical ranging dimension of or about 32.0 inches at a distance of or about 400.0 yards. Ranging mark 18 may include a lower ranging point comprising the bottommost edge 37 of the vertical crosshair 22 and an upper ranging point comprising the uppermost edge 42 of vertical crosshair 22, defining a length corresponding to an angular measurement A3 configured to auto-range a vertical ranging dimension of or about 32.0 inches at a distance of or about 500.0 yards. Ranging mark 19 may include a lower ranging point comprising the bottommost edge 38 of the vertical crosshair 23 and an upper ranging point comprising the uppermost edge 43 of vertical crosshair 23, defining a length corresponding to an angular measurement A4 configured to auto-range a vertical ranging dimension of or about 32.0 inches at a distance of or about 600.0 yards.

Referring to FIGS. 4 and 10, in an embodiment of a reticle 10, each of the vertically disposed ranging marks 16, 17, 18, 19 may include a lower ranging point and an upper ranging point, configured to auto-range a vertical ranging dimension of or about 36.0 inches at selected distances, including, but not limited to, distances of or about 300.0 yards, 400.0 yards, 500.0 yards, and 600.0 yards. In particular, ranging mark 16 may include a lower ranging point comprising the bottommost edge 35 of the vertical crosshair 20 and an upper ranging point comprising the bottommost edge 25 of the distance numeral “3” indicium, defining a length corresponding to an angular measurement A5 configured to auto-range a vertical ranging dimension of or about 36.0 inches at a distance of or about 300.0 yards. Ranging mark 17 may include a lower ranging point comprising the bottommost edge 36 of the vertical crosshair 21 and an upper ranging point comprising the bottommost edge 26 of the distance numeral “4” indicium, defining a length corresponding to an angular measurement A6 configured to auto-range a vertical ranging dimension of or about 36.0 inches at a distance of or about 400.0 yards. Ranging mark 18 may include a lower ranging point comprising the bottommost edge 37 of the vertical crosshair 22 and an upper ranging point comprising the bottommost edge 27 of the distance numeral “5” indicium, defining a length corresponding to an angular measurement A7 configured to auto-range a vertical ranging dimension of or about 36.0 inches at a distance of or about 500.0 yards. Ranging mark 19 may include a lower ranging point comprising the bottommost edge 38 of the vertical crosshair 23 and an upper ranging point comprising the bottommost edge 28 of the distance numeral “6” indicium, defining a length corresponding to an angular measurement A8 configured to auto-range a vertical ranging dimension of or about 36.0 inches at a distance of or about 600.0 yards.

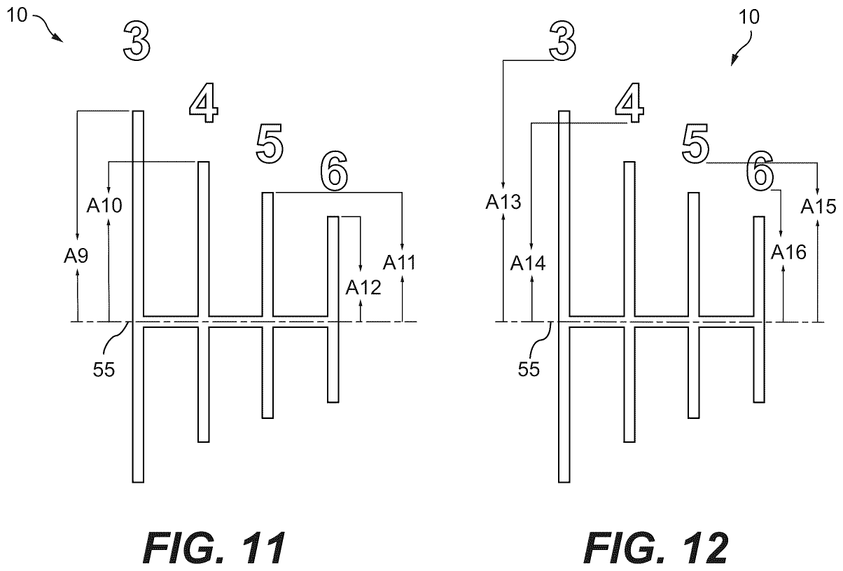

Referring to FIGS. 4 and 11, in an embodiment of a reticle 10, the horizontal crosshair 15 may include lower ranging points, with each of the vertically disposed ranging marks 16, 17, 18, 19 providing an upper ranging point for auto-ranging a vertical ranging dimension of or about 18.0 inches at selected distances, including, but not limited to, distances of or about 300.0 yards, 400.0 yards, 500.0 yards, and 600.0 yards. In particular, the horizontal crosshair 15 may include a midline 55, wherein a point of intersection between the midline 55 and each of the vertical crosshairs 20, 21, 22, 23 defines a lower ranging point. Each of the vertical crosshairs 20, 21, 22, 23 may include an upper ranging point at their respective uppermost edges 40, 41, 42, 43. Together, the lower and upper ranging points define lengths corresponding to angular measurements A9, A10, A11, A12, such that the lower and upper ranging points are configured to auto-range a vertical ranging dimension of or about 18.0 inches at distances of or about 300.0, 400.0, 500.0, and 600.0 yards, respectively.

Referring to FIGS. 4 and 12, in an embodiment of a reticle 10, the horizontal crosshair 15 may include lower ranging points, with each of the vertically disposed ranging marks 16, 17, 18, 19 providing an upper ranging point for auto-ranging a vertical ranging dimension of or about 22.0 inches at selected distances, including, but not limited to, distances of or about 300.0 yards, 400.0 yards, 500.0 yards, and 600.0 yards. In particular, a point of intersection between the midline 55 and each of the vertical crosshairs 20, 21, 22, 23 defines a lower ranging point and the distance numeral indicia “3,” “4,” “5,” and “6” may each include an upper ranging point at their respective bottommost edges 25, 26, 27, 28, defining lengths corresponding to angular measurements A13, A14, A15, and A16, such that the lower and upper ranging points are configured to auto-range a vertical ranging dimension of or about 22.0 inches at distances of or about 300.0, 400.0, 500.0, and 600.0 yards, respectively.

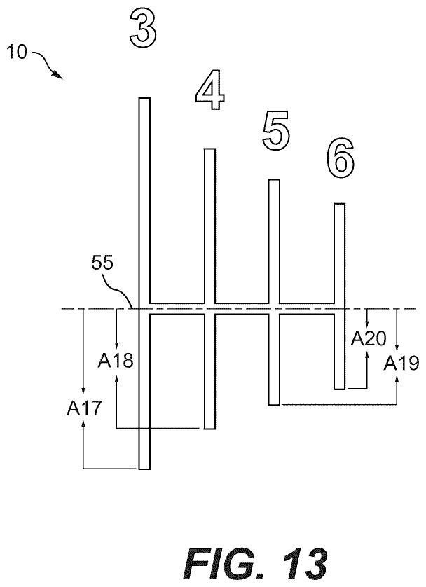

Referring to FIGS. 4 and 13, in an embodiment of a reticle 10, the horizontal crosshair 15 may include upper ranging points, with each of the vertically disposed ranging marks 16, 17, 18, 19 providing a lower ranging point for auto-ranging a vertical ranging dimension of or about 14.0 inches at selected distances, including, but not limited to, distances of or about 300.0 yards, 400.0 yards, 500.0 yards, and 600.0 yards. In particular, a point of intersection between the midline 55 and each of the vertical crosshairs 20, 21, 22, 23 defines an upper ranging point. Each of the vertical crosshairs 20, 21, 22, 23 may include a lower ranging point at their respective bottommost edges 35, 36, 37, 38. Together, the lower and upper ranging points define lengths corresponding to angular measurements A17, A18, A19, and A20, such that the lower and upper ranging points are configured to auto-range a vertical ranging dimension of or about 14.0 inches at distances of or about 300.0, 400.0, 500.0, and 600.0 yards, respectively.

In an embodiment, a reticle 10 of this disclosure may be configured within a viewing optic 5 such that a ranging scale 11 of the reticle 10 may be used by an operator to vertically auto-range a plurality of targets at a plurality of predetermined incremental distances from the reticle 10, each target being auto-ranged according to a particular vertical ranging dimension from a selection of vertical ranging dimensions, including, but not limited to, 14.0 inches, 18.0 inches, 22.0 inches, 32.0 inches, and 36.0 inches. By way of non-limiting illustration, the following discussion describes a ranging scale 11 of a reticle 10 having indicia sized on an optical medium 6 of a viewing optic 5 according to the specifications of the viewing optic 5 for vertically auto-ranging a plurality of quadrupeds, each quadruped being vertically auto-ranged according to a lower selected anatomical target reference point and an upper selected anatomical target reference point corresponding to a particular vertical ranging dimension from the following vertical ranging dimensions: of or about 14.0 inches; 18.0 inches; 22.0 inches; 32.0 inches; and 36.0 inches.

In an embodiment, a ranging scale 11 of a reticle 10 of this disclosure may include a configuration of indicia effective to vertically auto-range a grouping of quadrupeds, including (1) at least four adult-size members of the Cervidae family at lower and upper selected anatomical target reference points including belly-to-back target reference points, such members including (a) one or more members of the Cervidae family having an average belly-to-back vertical ranging dimension of or about 18.0 inches, (b) one or more members of the Cervidae family having an average belly-to-back vertical ranging dimension of or about 22.0 inches, (c) one or more members of the Cervidae family having an average belly-to-back vertical ranging dimension of or about 32.0 inches, and (d) one or more members of the Cervidae family having an average belly-to-back vertical ranging dimension of or about 36.0 inches; (2) at least two adult-size members of the Canidae family at lower and upper selected anatomical target reference points including paw-to-back target reference points at a standing position, such members including (a) one or more members of the Canidae family having an average paw-to-back vertical ranging dimension of or about 14.0 inches at a standing position and (b) one or more members of the Canidae family having an average paw-to-back vertical ranging dimension of or about 18.0 inches at a standing position; and (3) at least one adult-size member of the Canidae family at lower and upper selected anatomical target reference points including belly-to-back target reference points, such member including at least one member of the Canidae family having an average belly-to-back vertical ranging dimension of or about 9.0 inches.

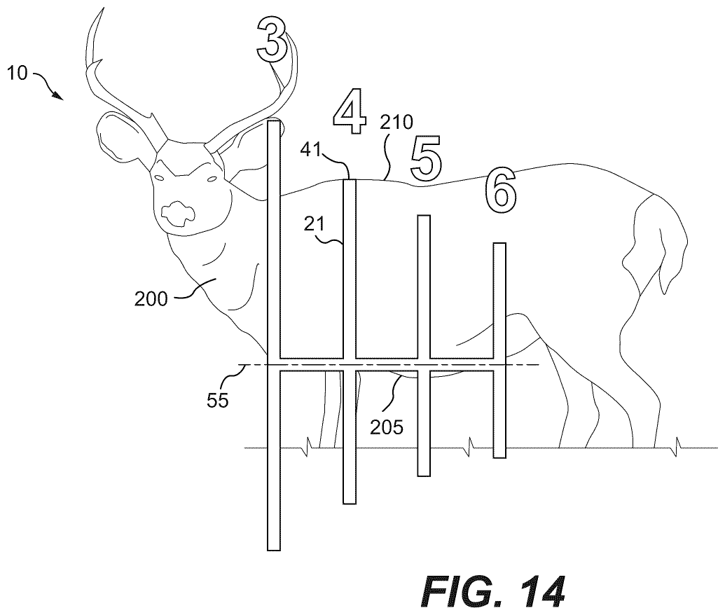

In a non-limiting example, a member of the Cervidae family having an average belly-to-back vertical ranging dimension of or about 18.0 inches may include a white-tailed deer (Odocoileus virginianus), hereafter “white-tailed deer 200.” As shown in FIG. 14, an operator may vertically auto-range a white-tailed deer 200 using the ranging scale 11 of a reticle 10 of this disclosure by aligning, or substantially aligning, the midline 55 of the horizontal crosshair 15 with the belly 205 of the white-tailed deer 200 as shown and noting which of the uppermost edges 40, 41, 42, 43 of the vertical crosshairs 20, 21, 22, 23 most closely aligns with the back 210 of the white-tailed deer 200. In the example of FIG. 14, the back 210 of the white-tailed deer 200 is shown aligned, or substantially aligned, with the uppermost edge 41 of the vertical crosshair 21, indicating that the white-tailed deer 200 is at a distance of or about 400.0 yards from the ranging scale 11, corresponding to the distance numeral “4” indicium of ranging mark 17, which represents a distance of 400.0 yards in this example. Similarly, if an operator aligns, or substantially aligns, the midline 55 of the horizontal crosshair 15 with the belly 205 of the white-tailed deer 200, and the back 210 of the white-tailed deer 200 is aligned, or substantially aligned, with the uppermost edge 40 of the vertical crosshair 20, then the white-tailed deer 200 is a distance of or about 300.0 yards from the ranging scale 11, corresponding to the distance numeral “3” indicium of ranging mark 16, which represents a distance of 300.0 yards in this example. If an operator aligns, or substantially aligns, the midline 55 of the horizontal crosshair 15 with the belly 205 of the white-tailed deer 200, and the back 210 is aligned, or substantially aligned, with the uppermost edge 42 of the vertical crosshair 22, then the white-tailed deer 200 is at a distance of or about 500.0 yards from the ranging scale 11, corresponding to the distance numeral “5” indicium of the ranging mark 18, which represents a distance of 500.0 yards in this example. If an operator aligns, or substantially aligns, the midline 55 of the horizontal crosshair 15 with the belly 205 of the white-tailed deer 200, and the back 210 is aligned, or substantially aligned, with the uppermost edge 43 of the vertical crosshair 23, then the white-tailed deer 200 is at a distance of or about 600.0 yards from the ranging scale 11, corresponding to the distance numeral “6” indicium of ranging mark 19, which represents a distance of 600.0 yards in this example. Estimated distances may also be determined where the back 210 of a white-tailed deer 200 is viewed at a position above the midline 55 of the horizontal crosshair 15 between adjacent uppermost edges 40, 41, 42, 43 of the vertical crosshairs 20, 21, 22, 23. For example, in a scenario where an operator aligns or substantially aligns the belly 205 of the white-tailed deer 200 with the midline 55 of the horizontal crosshair 15 and the back 210 of the white-tailed deer 200 is viewed at or near a halfway point between adjacent uppermost edges 40 and 41, an operator may estimate that the white-tailed deer 200 is a distance of or about 350.0 yards from the ranging scale 11.

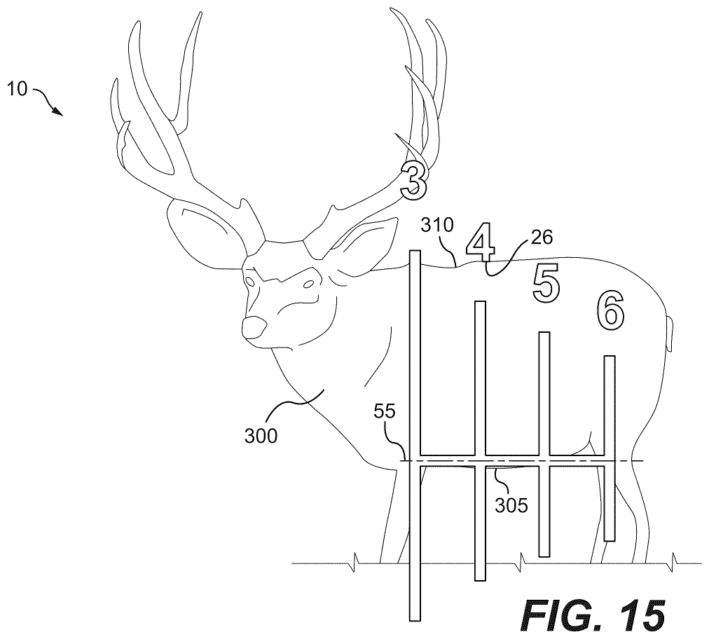

In a non-limiting example, a member of the Cervidae family having an average belly-to-back vertical ranging dimension of or about 22.0 inches may include a mule deer (Odocoileus hemionus), hereafter “mule deer 300.” As shown in FIG. 15, an operator may vertically auto-range a mule deer 300 using the ranging scale 11 of a reticle 10 of this disclosure by aligning, or substantially aligning, the midline 55 of the horizontal crosshair 15 with the belly 305 of the mule deer 300 as shown and noting which of the bottommost edges 25, 26, 27, 28 of the distance numeral indicia most closely aligns with the back 310 of the mule deer 300. In the example of FIG. 15, the back 310 of the mule deer 300 is viewed aligned, or substantially aligned, with the bottommost edge 26 of the distance numeral “4” indicium, indicating that the mule deer 300 is at a distance of or about 400.0 yards from the ranging scale 11, corresponding to the distance numeral “4” indicium of ranging mark 17, which represents a distance of 400.0 yards in this example. Similarly, when an operator aligns, or substantially aligns, the midline 55 of the horizontal crosshair 15 with the belly 305 of the mule deer 300 and the back 310 of the mule deer 300 is aligned, or substantially aligned, with the bottommost edge 25 of the distance numeral “3” indicium, then the mule deer 300 is a distance of or about 300.0 yards from the ranging scale 11, corresponding to the distance numeral “3” indicium of the ranging mark 16, which represents a distance of 300.0 yards in this example. When an operator aligns, or substantially aligns, the midline 55 of the horizontal crosshair 15 with the belly 305 of the mule deer 300 and the back 310 of the mule deer 300 is aligned, or substantially aligned, with the bottommost edge 27 of the distance numeral “5” indicium, then the mule deer 300 is a distance of or about 500.0 yards from the ranging scale 11, corresponding to the distance numeral “5” indicium of the ranging mark 18, which represents a distance of 500.0 yards in this example. When an operator aligns, or substantially aligns, the midline 55 of the horizontal crosshair 15 with the belly 305 of the mule deer 300 and the back 310 of the mule deer 300 is aligned, or substantially aligned, with the bottommost edge 28 of the distance numeral “6” indicium, then the mule deer 300 is a distance of or about 600.0 yards from the ranging scale 11, corresponding to the distance numeral “6” indicium of the ranging mark 19, which represents a distance of 600.0 yards in this example.

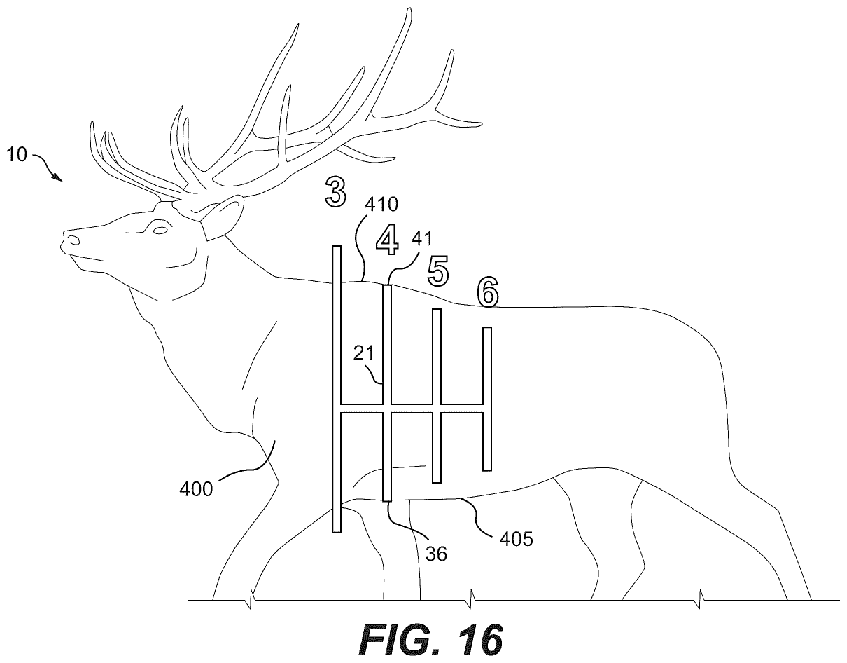

In a non-limiting example, a member of the Cervidae family having an average belly-to-back vertical ranging dimension of or about 32.0 inches may include an elk (Cervus canadensis), hereafter “clk 400.” As shown in FIG. 16, an operator may vertically auto-range an elk 400 using the ranging scale 11 of a reticle 10 of this disclosure by noting which of the vertical crosshairs 20, 21, 22, 23 best corresponds to the vertical height of the elk 400 from belly 405 to back 410, wherein a bottommost edge 35, 36, 37, 38 of one of the vertical crosshairs 20, 21, 22, 23 is aligned, or substantially aligned, with the belly 405, and a corresponding uppermost edge 40, 41, 42, 43 of the vertical crosshairs 20, 21, 22, 23 is aligned, or substantially aligned, with the back 410 of the elk 400. In the example of FIG. 16, vertical crosshair 21 best corresponds to the vertical height of the elk 400 from belly 405 to back 410, wherein the bottommost edge 36 of vertical crosshair 21 is aligned, or substantially aligned, with the belly 405 and the corresponding uppermost edge 41 of the vertical crosshair 21 is aligned, or substantially aligned, with the back 410, indicating that the elk 400 is at a distance of or about 400.0 yards from the ranging scale 11 according to the corresponding distance numeral “4” indicium of ranging mark 17, which represents a distance of 400.0 yards in this example. Similarly, when vertical crosshair 20 best matches the vertical height of the elk 400 from belly 405 to back 410, such that the bottommost edge 35 of vertical crosshair 20 is aligned, or substantially aligned, with the belly 405 and the corresponding uppermost edge 40 is aligned, or substantially aligned, with the back 410, the elk 400 is at a distance of or about 300.0 yards from the ranging scale 11 according to the corresponding distance numeral “3” indicium of ranging mark 16, which represents a distance of 300.0 yards in this example. In further scenarios, the same process may be applied using vertical crosshairs 22 and 23. For example, when the bottommost edge 37 of vertical crosshair 22 is aligned, or substantially aligned, with the belly 405 of the elk 400 and the corresponding uppermost edge 42 of vertical crosshair 22 is aligned, or substantially aligned, with the back 410, the elk 400 is determined to be at a distance of or about 500.0 yards from the ranging scale 11 according to the corresponding distance numeral “5” indicium of ranging mark 18, which represents a distance of 500.0 yards in this example. Likewise, when the bottommost edge 38 of vertical crosshair 23 is aligned, or substantially aligned, with the belly 405 and the corresponding uppermost edge 43 is aligned, or substantially aligned, with the back 410, the elk 400 is determined to be at a distance of or about 600.0 yards from the ranging scale 11 according to the corresponding distance numeral “6” indicium of ranging mark 19, which represents a distance of 600.0 yards in this example.

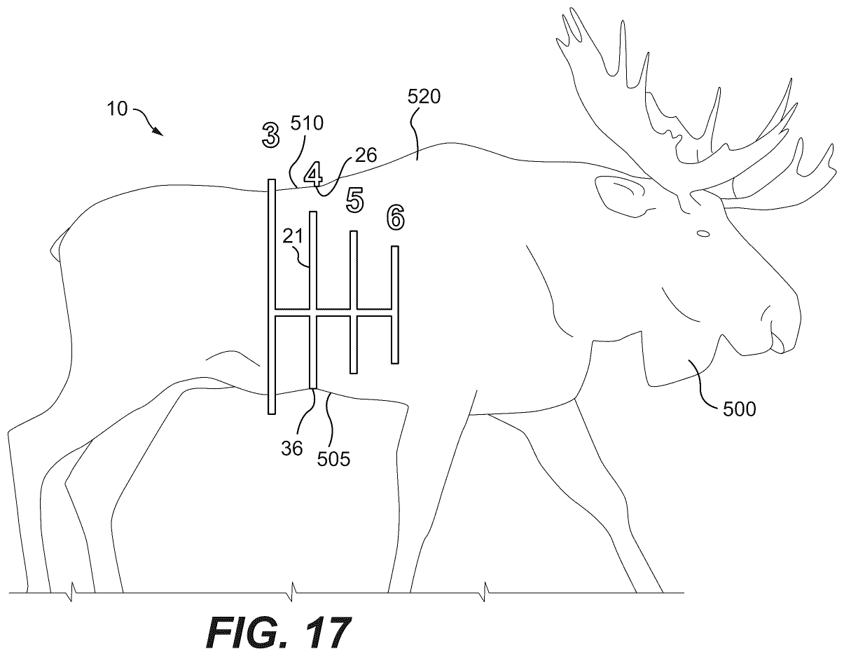

In a non-limiting example, a member of the Cervidae family having an average belly-to-back vertical ranging dimension of or about 36.0 inches may include a moose (Alces alces), hereafter “moose 500.” As shown in FIG. 17, an operator may vertically auto-range a moose 500 from belly 505 to back 510 using the ranging scale 11 of a reticle 10 of this disclosure by determining which of the vertically disposed ranging marks 16, 17, 18, 19 best corresponds to vertical height of the moose 500. In this embodiment, the bottommost edges 35, 36, 37, 38 of the vertical crosshairs 20, 21, 22, 23 operate as lower ranging points for aligning, or substantially aligning, with the belly 505, while the bottommost edges 25, 26, 27, 28 of the distance numeral indicia operate as upper ranging points for aligning, or substantially aligning, with the back 510. For purposes of vertically auto-ranging a moose 500, the back 510 is defined as the portion of the back located behind or rearward of the shoulder hump 520, as shown in FIG. 17.

In the example of FIG. 17, ranging mark 17 best matches the moose 500 vertically from belly 505 to back 510, whereby the bottommost edge 36 of the vertical crosshair 21 is aligned, or substantially aligned, with the belly 505 and the corresponding bottommost edge 26 of the distance numeral “4” indicium is aligned, or substantially aligned, with the back 510. This alignment indicates that the moose 500 is at a distance of or about 400.0 yards from the ranging scale 11 according to the corresponding distance numeral “4” indicium of ranging mark 17, which represents a distance of 400.0 yards in this example. Similarly, when the bottommost edge 35 of vertical crosshair 20 is aligned, or substantially aligned, with the belly 505 and the corresponding bottommost edge 25 of the distance numeral “3” indicium is aligned, or substantially aligned, with the back 510, then the moose 500 is at a distance of or about 300.0 yards from the ranging scale 11 according to the corresponding distance numeral “3” indicium of ranging mark 16, which represents a distance of 300.0 yards in this example. When the bottommost edge 37 of vertical crosshair 22 is aligned, or substantially aligned, with the belly 505 and the corresponding bottommost edge 27 of distance numeral “5” indicium is aligned, or substantially aligned, with the back 510, then the moose 500 is at a distance of or about 500.0 yards from the ranging scale 11 according to the corresponding distance numeral “5” indicium of ranging mark 18, which represents a distance of 500.0 yards in this example. Likewise, when the bottommost edge 38 of vertical crosshair 23 is aligned, or substantially aligned, with the belly 505 of the moose 500 and the corresponding bottommost edge 28 of distance numeral “6” indicium is aligned, or substantially aligned, with the back 510, then the moose 500 is a distance of or about 600.0 yards from the ranging scale 11 according to the corresponding distance numeral “6” indicium of ranging mark 19, which represents a distance of 600.0 yards in this example.

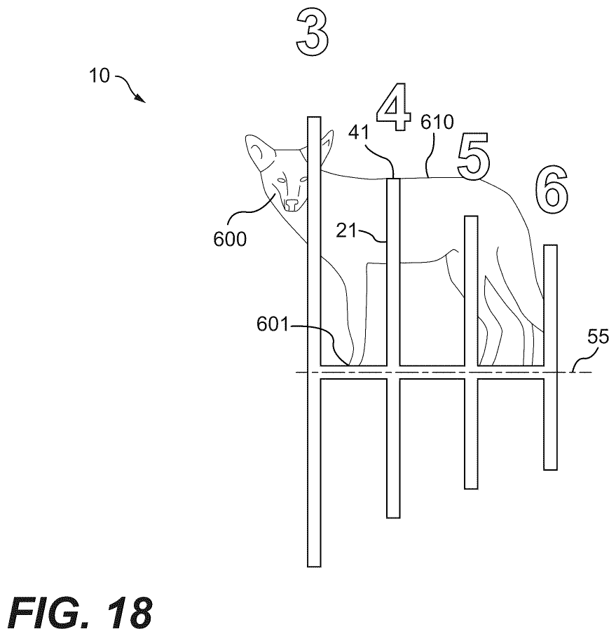

In a non-limiting example, a member of the Canidae family having an average paw-to-back vertical ranging dimension of or about 18.0 inches may include a coyote (Canis latrans), hereafter “coyote 600.” With reference to FIG. 18, an operator may vertically auto-range a standing coyote 600 using the ranging scale 11 of a reticle 10 of this disclosure by aligning, or substantially aligning, the midline 55 of the horizontal crosshair 15 with a paw 601 of the coyote 600 and noting which uppermost edge 40, 41, 42, 43 of the vertical crosshairs 20, 21, 22, 23 most closely aligns with the back 610 of the coyote 600. When the midline 55 of horizontal crosshair 15 is aligned, or substantially aligned, with the paw 601 and the back 610 is aligned, or substantially aligned, with the uppermost edge 41 of the vertical crosshair 21 as shown, then the coyote 600 is a distance of or about 400.0 yards from the ranging scale 11 according to the corresponding distance numeral “4” indicium of ranging mark 17, which represents a distance of 400.0 yards in this example. Based on the morphological characteristics of a coyote 600 (e.g., the spatial layout of the forelimbs and hindlimbs of a coyote 600), any point along the midline 55 of the horizontal crosshair 15 may be used as a lower ranging point as shown in FIG. 18.

With further reference to FIG. 18, when the midline 55 of the horizontal crosshair 15 is aligned, or substantially aligned, with the paw 601 and the back 610 is aligned, or substantially aligned, with the uppermost edge 40 of the vertical crosshair 20, then the coyote 600 is a distance of or about 300.0 yards from the ranging scale 11 according to the corresponding distance numeral “3” indicium of ranging mark 16, which represents a distance of 300.0 yards in this example. When the midline 55 of the horizontal crosshair 15 is aligned, or substantially aligned, with the paw 601 and the back 610 is aligned, or substantially aligned, with the uppermost edge 42 of the vertical crosshair 22, then the coyote 600 is a distance of or about 500.0 yards from the ranging scale 11 according to the corresponding distance numeral “5” indicium of ranging mark 18, which represents a distance of 500.0 yards in this example. When the midline 55 of the horizontal crosshair 15 is aligned, or substantially aligned, with the paw 601 and the back 610 is aligned, or substantially aligned, with the uppermost edge 43 of the vertical crosshair 23, then the coyote 600 is a distance of or about 600.0 yards from the ranging scale 11 according to the corresponding distance numeral “6” indicium of ranging mark 19, which represents a distance of 600.0 yards in this example.

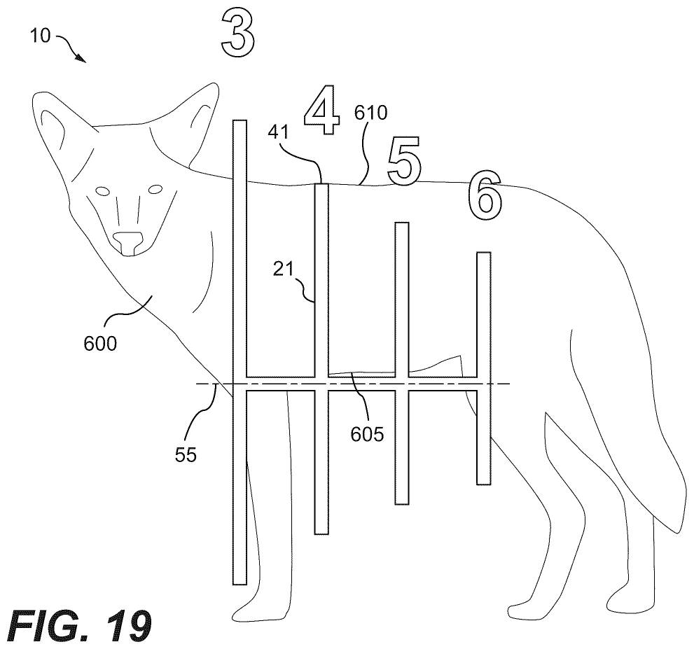

In a non-limiting example, a coyote 600 having an average paw-to-back vertical ranging dimension of or about 18.0 inches may also be vertically auto-ranged using a ranging scale 11 of a reticle 10 of this disclosure when the coyote 600 is located at one or more distances of or about 300.0 yards or less from the ranging scale 11 by aligning the belly 605 of the coyote 600 at or near the midline 55 of the horizontal crosshair 15 and noting which of the uppermost edges 40, 41, 42, 43 of the vertical crosshairs 20, 21, 22, 23 most closely aligns with the back 610 of the coyote 600. Considering that a coyote 600 has a vertical ranging dimension from belly 605 to back 610 of or about half of the average paw-to-back vertical ranging dimension of 18.0 inches (i.e., a vertical ranging dimension from belly 605 to back 610 of or about 22.9 cm (9.0 inches)), once the coyote 600 is vertically aligned belly 605 to back 610 via the midline 55 of the horizontal crosshair 15 and one of the uppermost edges 40, 41, 42, 43, the distance of the coyote 600 from the ranging scale 11 may be determined as a distance of or about half the distance of the corresponding distance numeral indicium. With reference to FIG. 19, when an operator aligns, or substantially aligns, the midline 55 of the horizontal crosshair 15 with the belly 605 of the coyote 600 as shown and the back 610 of the coyote 600 is viewed aligned, or substantially aligned, with the uppermost edge 41 of the vertical crosshair 21 of vertical ranging mark 17, then the coyote 600 is a distance of or about 200.0 yards from the ranging scale 11 according to the distance numeral “4” indicium of ranging mark 17, which represents a distance of 400.0 yards in this example.

Similarly, when an operator aligns, or substantially aligns, the midline 55 of the horizontal crosshair 15 with the belly 605 of the coyote 600 and the back 610 of the coyote 600 is viewed aligned, or substantially aligned, with the uppermost edge 40 of the vertical crosshair 20, then the coyote 600 is a distance of or about 150.0 yards from the ranging scale 11 according to the corresponding distance numeral “3” indicium of ranging mark 16, which represents a distance of 300.0 yards in this example. When the midline 55 of the horizontal crosshair 15 is aligned, or substantially aligned, with the belly 605 of the coyote 600 and the back 610 of the coyote 600 is viewed aligned, or substantially aligned, with the uppermost edge 42 of the vertical crosshair 22, then the coyote 600 is a distance of or about 250.0 yards from the ranging scale 11 according to the corresponding distance numeral “5” indicium of ranging mark 18, which represents a distance of 500.0 yards in this example. When the midline 55 of the horizontal crosshair 15 is aligned, or substantially aligned, with the belly 605 of the coyote 600 and the back 610 is viewed aligned, or substantially aligned, with the uppermost edge 43 of the vertical crosshair 23, then the coyote 600 is a distance of or about 300.0 yards from the ranging scale 11 according to the corresponding distance numeral “6” indicium of ranging mark 19, which represents a distance of 600.0 yards in this example.

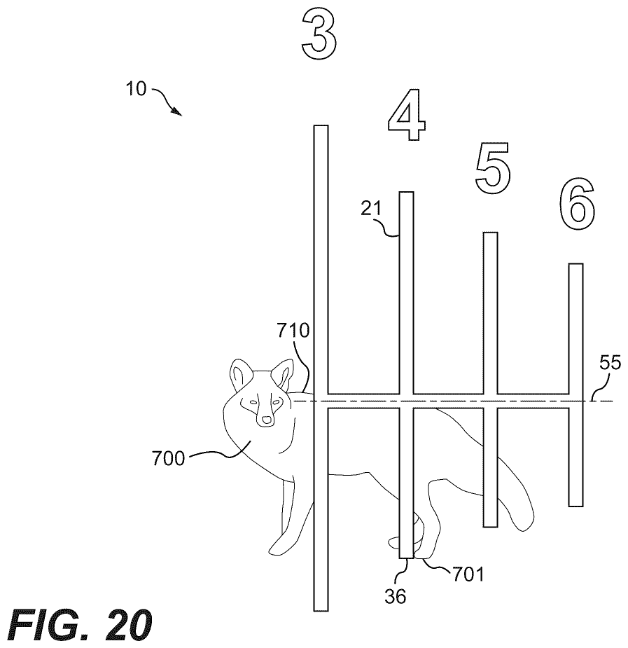

As stated above, a ranging scale 11 of a reticle 10 of this disclosure may be configured to vertically auto-range one or more members of the Canidae family having an average paw-to-back vertical ranging dimension of or about 14.0 inches in a standing position. As shown in FIG. 20, an operator may vertically auto-range a standing member of the Canidae family such as an American red fox (Vulpes vulpes fulva), hereafter “fox 700,” using the ranging scale 11 of a reticle 10 by aligning, or substantially aligning, the midline 55 of the horizontal crosshair 15 with the back 710 of the fox 700 as shown and noting which bottommost edge 35, 36, 37, 38 of the vertical crosshairs 20, 21, 22, 23 most closely aligns with the paw 701 of the fox 700. In the example of FIG. 20, the back 710 of the fox 700 is viewed aligned, or substantially aligned, with the midline 55 of the horizontal crosshair 15, and the paw 701 of the fox 700 is viewed aligned, or substantially aligned, with bottommost edge 36 of vertical crosshair 21, based on the morphological characteristics of a fox 700, indicating that the fox 700 is a distance of or about 400.0 yards from the ranging scale 11 according to the corresponding distance numeral “4” indicium of ranging mark 17, which represents a distance of 400.0 yards in this example. Similarly, when the midline 55 of the horizontal crosshair 15 is aligned, or substantially aligned, with the back 710 and the paw 701 is aligned, or substantially aligned, with the bottommost edge 35 of the vertical crosshair 20, then the fox 700 is a distance of or about 300.0 yards from the ranging scale 11 according to the corresponding distance numeral “3” indicium of ranging mark 16, which represents a distance of 300.0 yards in this example. When the midline 55 of the horizontal crosshair 15 is aligned, or substantially aligned, with the back 710 and the paw 701 is aligned, or substantially aligned, with the bottommost edge 37 of the vertical crosshair 22, then the fox 700 is a distance of or about 500.0 yards from the ranging scale 11 according to the corresponding distance numeral “5” indicium of ranging mark 18, which represents a distance of 500.0 yards in this example. When the midline 55 of the horizontal crosshair 15 is aligned, or substantially aligned, with the back 710 and the paw 701 is aligned, or substantially aligned, with the bottommost edge 38 of the vertical crosshair 23, then the fox 700 is a distance of or about 600.0 yards from the ranging scale 11 according to the corresponding distance numeral “6” indicium of ranging mark 19, which represents a distance of 600.0 yards in this example.

As described above with reference to FIGS. 14-20, the one or more horizontally disposed ranging marks 15 and the vertically disposed ranging marks 16, 17, 18, 19 of the reticle 10 include various ranging points that are combinable into different sets of lower ranging points and upper ranging points. For example, in an embodiment, points along the midline 55 of the horizontal crosshair 15, as described above, and the uppermost edges 40, 41, 42, 43 of the vertical crosshairs 20, 21, 22, 23, may be referred to as a first set of ranging points. In addition, in an embodiment, points along the midline 55 of the horizontal crosshair 15 and the bottommost edges 25, 26, 27, 28 of the distance numeral indicia may be referred to as a second set of ranging points. In an embodiment, the bottommost edges 35, 36, 37, 38 of the vertical crosshairs 20, 21, 22, 23 and the uppermost edges 40, 41, 42, 43 of the vertical crosshairs 20, 21, 22, 23 may be referred to as a third set of ranging marks. In an embodiment, the bottommost edges 35, 36, 37, 38 of the vertical crosshairs 20, 21, 22, 23 and the bottommost edges 25, 26, 27, 28 of the distance numeral indicia may be referred to as a fourth set of ranging marks. In an embodiment, points along the midline 55 of the horizontal crosshair 15 and the bottommost edges 35, 36, 37, 38 of the vertical crosshairs 20, 21, 22, 23 may be referred to as a fifth set of ranging marks.

In an embodiment, the various ranging points of the one or more horizontally disposed ranging marks 15 and the vertically disposed ranging marks 16, 17, 18, 19 may be combined into sets of lower ranging points and upper ranging points different than as described above. For example, in an embodiment, the bottommost edges 35, 36, 37, 38 of the vertical crosshairs 20, 21, 22, 23 and the uppermost edges 40, 41, 42, 43 of the vertical crosshairs 20, 21, 22, 23 may be referred to as a first set of ranging points. Likewise, in an embodiment, the points along the midline 55 of the horizontal crosshair 15 and the bottommost edges 35, 36, 37, 38 of the vertical crosshairs 20, 21, 22, 23 may be referred to as a first set of ranging points.

Although the above non-limiting examples describe a grouping of particular quadrupeds, each having a vertical ranging dimension selected from 14.0 inches, 18.0 inches, 22.0 inches, 32.0 inches, or 36.0 inches, other targets, including, but not limited to, one or more additional quadrupeds and/or bipeds with lower and upper selected anatomical target reference points within these vertical ranging dimensions, may also be auto-ranged using the ranging scale 11 described above. In another embodiment, a ranging scale 11 of this disclosure may be configured within a viewing optic 5 to vertically auto-range one or more targets or groupings of targets according to one or more vertical ranging dimensions different from those described above with reference to FIGS. 14-20, including, but not limited to, one or more quadrupeds and/or bipeds.

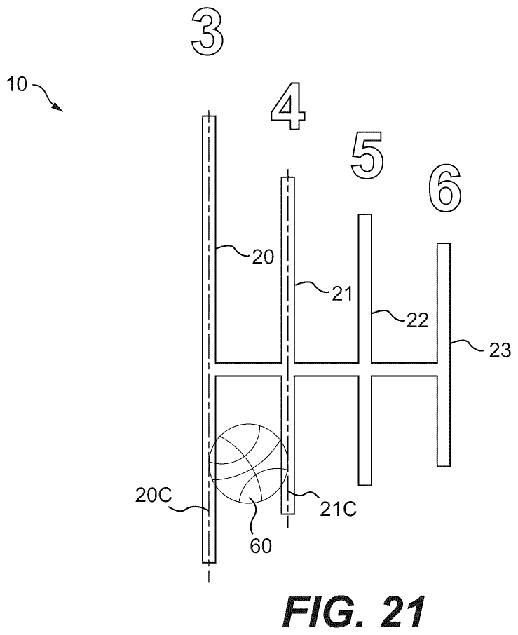

As stated above, in addition to auto-ranging, the vertical crosshairs 20, 21, 22, 23 may be graduated in angular measurement increments for horizontal range estimation of one or more targets of known dimensions by applying formulas known in the art of MRAD reticles. Referring to FIG. 21, in a non-limiting example of horizontal range estimation of a target such as a basketball 60 having a known outer diameter of or about 25.4 cm (10.0 inches), and with the vertical crosshairs 20, 21, 22, 23 graduated in 0.5 MRAD increments, an operator may position the vertical crosshairs 20, 21, 22, 23 over the basketball 60 as shown (in phantom), aligning a midline of a selected vertical crosshair at or near left side of the basketball 60 as a baseline mark, and then measure or count the number of MRADs to the right side of the basketball 60. In the example of FIG. 21, when the left side of the basketball 60 is aligned, or substantially aligned, with the midline 20C of the vertical crosshair 20, the basketball 60 spans a measured 0.5 MRAD to the midline 21C of the adjacent vertical crosshair 21. The estimated range of the basketball 60 from the ranging scale 11, expressed in yards, may then be calculated using what is commonly referred to in the art of firearm ranging as the “MIL Relation Formula” set forth in Table 5.

TABLE 5
Size of Target (inches) / MRAD Size of Target × 27.77 = Distance (yards)

As stated above, the basketball 60, having a known diameter of or about 25.4 cm (10.0 inches), covers a measured 0.5 MRAD. By dividing the known diameter of 10.0 by the measured 0.5 MRAD and multiplying the result, i.e., result of 20.0, by 27.77, the estimated range is calculated to be 555.4 yards. Accordingly, the basketball 60 is a distance of or about 555.4 yards from the ranging scale 11 in the example of FIG. 21.

Also, the estimated range of the basketball 60 from the ranging scale 11 in meters may be calculated using a MIL Relation Formula set forth in Table 6.

TABLE 6
Size of Target (inches) × 25.4 / MRAD Size of Target = Distance (meters)

As stated above, the basketball 60 covers a measured 0.5 MRAD. By multiplying 10.0 inches by 25.4 to convert to 254 millimeters, and then dividing 254 by 0.5, the result is 508.0 meters, which means that the basketball 60 is a distance of or about 508.0 meters from the ranging scale 11 in the example of FIG. 21.

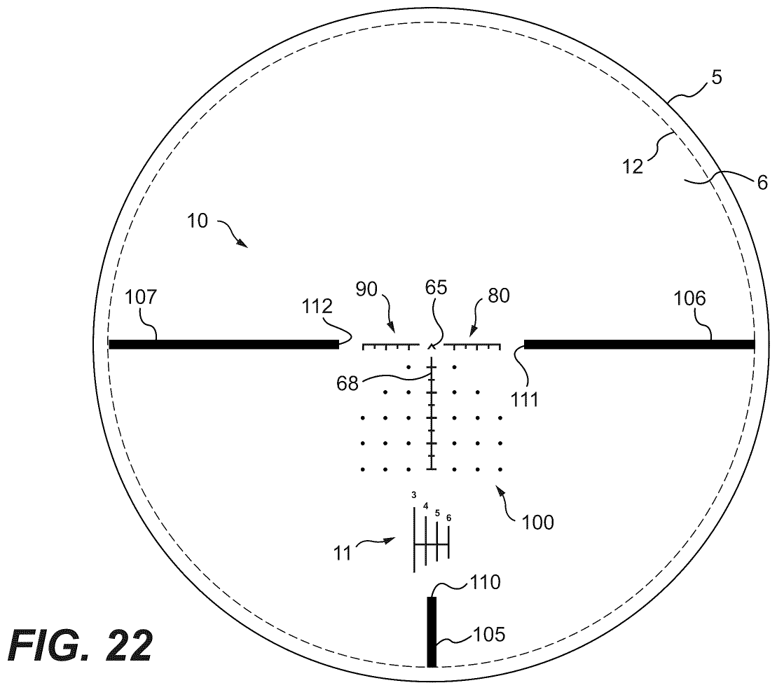

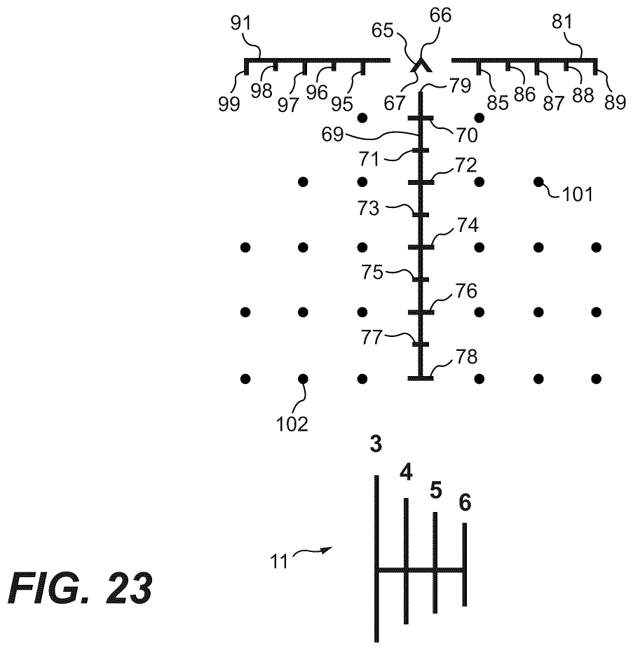

With reference to FIGS. 22-26, in an embodiment, a reticle 10 of this disclosure may include one or more marks in addition to a ranging scale 11. For example, a reticle 10 may include graduated marks graduated in angular measurement, including at least (1) a first measurement mark 65 and (2) a second measurement mark 68 comprising one or more subtension marks. As shown in FIG. 22, in an embodiment, the first measurement mark 65 may be set at the optical axis of the viewing optic 5 on an optical medium 6, wherein at least part of the first measurement mark 65 defines a center point of the reticle 10. The first measurement mark 65 may be configured for initial target acquisition of one or more particular targets at a predetermined or selected base distance from the reticle 10. In this embodiment, the first measurement mark 65 includes a chevron with an uppermost edge (or “upper tip 66”) located at the optical axis of the viewing optic 5 and two legs defining a base 67 of the first measurement mark 65 (see FIG. 23). In another embodiment, the first measurement mark 65 may include one or more other indicia as described above.

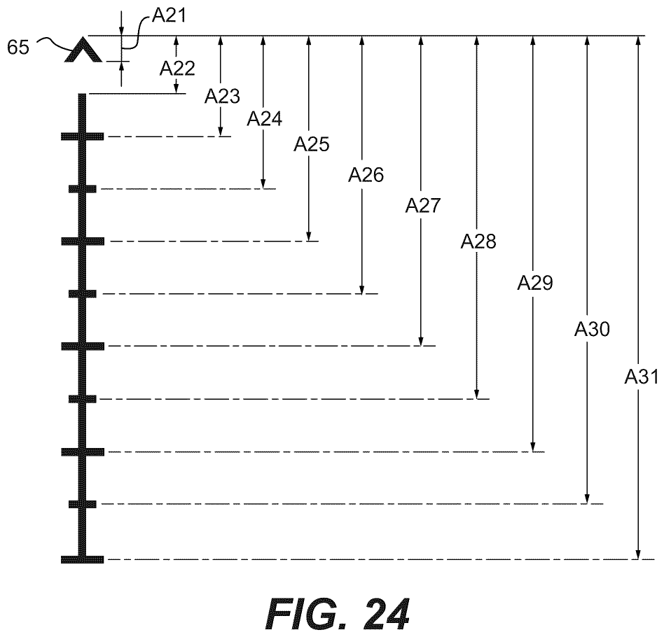

Referring to FIG. 23, the second measurement mark 68 may include a vertical crosshair-type indicia in the form of a central vertical line or post (herein referred to as “central vertical crosshair 69”) and one or more horizontal crosshair-type indicia bisected by the central vertical crosshair 69 (herein referred to as “horizontal crosshairs 70, 71, 72, 73, 74, 75, 76, 77, 78”). As shown, the second measurement mark 68 may be located below and in linear alignment with the first measurement mark 65, wherein the first measurement mark 65, the central vertical crosshair 69 and the horizontal crosshairs 70-78 are configured as graduated marks graduated in angular measurement. For example, in an embodiment, the upper tip 66 of the first measurement mark 65 may be configured as a point-of-origin aiming mark of the reticle 10, and the base 67 of the first measurement mark 65 may be configured as a first MRAD subtension mark (e.g., 0.25 MRAD mark). An uppermost edge 79 of the central vertical crosshair 69 may be configured as a second MRAD subtension mark (e.g., 0.5 MRAD mark) and the horizontal crosshairs 70-78 may be configured as MRAD subtension marks disposed below the uppermost edge 79. With reference to FIG. 24, MRAD measurements for the first measurement mark 65 and the second measurement mark 68 of an embodiment of the reticle 10 are provided in Table 7.

TABLE 7

| | MRAD |
|---|---|
| A21: | 0.25 |
| A22: | 0.50 |
| A23: | 1.00 |
| A24: | 1.50 |
| A25: | 2.00 |
| A26: | 2.50 |
| A27: | 3.00 |
| A28: | 3.50 |
| A29: | 4.00 |
| A30: | 4.50 |
| A31: | 5.00 |

As shown in FIG. 23, in an embodiment, and for ease of use, the MRAD horizontal crosshairs 70, 72, 74, 76, 78 may each include a common first length, and the MRAD horizontal crosshairs 71, 73, 75, 77 may each include a common second length that is less than the first length. In an embodiment, MRAD horizontal crosshairs 71, 73, 75, 77 may each have a common second length that is greater than the first length. In an embodiment, each of the horizontal crosshairs 70-78 may include a common length. In an embodiment, each of the horizontal crosshairs 70-78 may have dissimilar lengths.

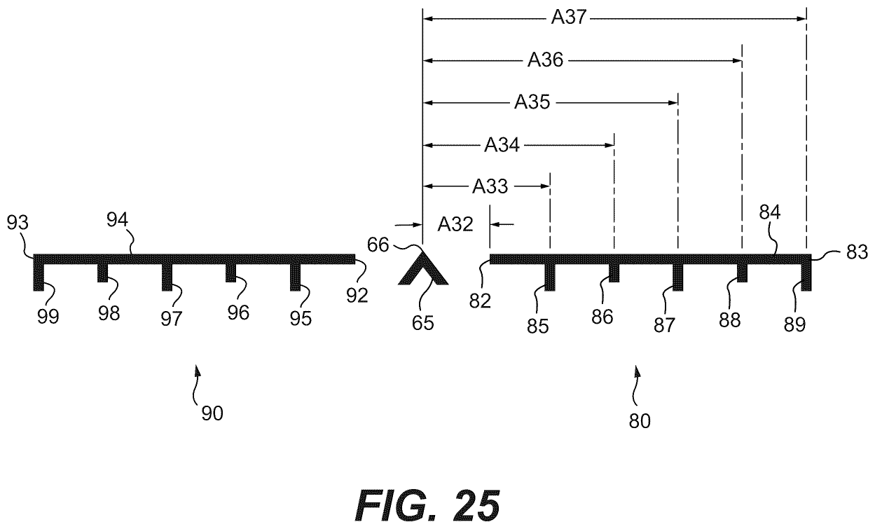

As shown in FIG. 22, a reticle 10 of this disclosure may also include a third measurement mark 80, depicted as a first side scale indicia positioned to the right of the first measurement mark 65, and/or a fourth measurement mark 90, depicted as a second side scale indicia positioned to the left of the first measurement mark 65. With particular reference to FIGS. 23 and 25, in an embodiment, the third measurement mark 80 may include (1) a horizontal crosshair 81 comprising a proximal end 82 and a distal end 83, wherein an upper surface 84 of the horizontal crosshair 81 is aligned, or substantially aligned, lengthwise with the upper tip 66 of the first measurement mark 65, and (2) one or more vertical marks or lines (“vertical crosshairs 85, 86, 87, 88, 89”) extending downward from the horizontal crosshair 81 at selected points along the length of the horizontal crosshair 81 and graduated in angular measurement increments. In an embodiment, the fourth measurement mark 90 may be provided in a mirror-image configuration of the third measurement mark 80, including (1) a horizontal crosshair 91 having a proximal end 92 and a distal end 93, wherein an upper surface 94 of the horizontal crosshair 91 is aligned, or substantially aligned, lengthwise with the upper tip 66 of the first measurement mark 65, and (2) one or more vertical marks or lines (“vertical crosshairs 95, 96, 97, 98, 99”) extending downward from the horizontal crosshair 91 at selected points along the length of the horizontal crosshair 91 and graduated in angular measurement increments.

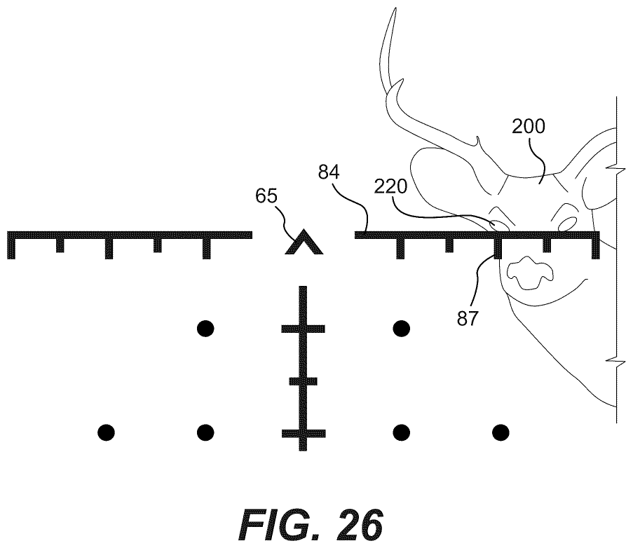

In an embodiment, the vertical crosshairs 85, 86, 87, 88, 89 may extend upward from the horizontal crosshair 81, and/or the vertical crosshairs 95, 96, 97, 98, 99 may extend upward from the horizontal crosshair 91. In an embodiment, the vertical crosshairs 85, 86, 87, 88, 89 may intersect the horizontal crosshair 81 extending both downward and upward from the horizontal crosshair 81, and/or the vertical crosshairs 95, 96, 97, 98, 99 may intersect the horizontal crosshair 91 extending both downward and upward from the horizontal crosshair 91. Suitably, the vertical crosshairs 85, 86, 87, 88, 89 extend downward from the horizontal crosshair 81, and the vertical crosshairs 95, 96, 97, 98, 99 extend downward from the horizontal crosshair 91, as shown, to maximize use of the upper surfaces 84 and 94 of the respective horizontal crosshairs 81 and 91 by minimizing target obstruction above the horizontal crosshairs 81 and 91 for aiming purposes. For example, FIG. 26 illustrates use of the upper surface 84 of the horizontal crosshair 81 at vertical crosshair 87 as a point of aim at a right eye 220 of a white-tailed deer 200 in a scenario where a shooter is holding 2.0 MRAD for wind, as understood by the skilled artisan.

With reference to FIG. 25, angular measurements for an embodiment of the third measurement mark 80, as illustrated in reference to FIG. 26, are provided in Table 8. According to the mirror-image configuration of the third and fourth measurement marks 80 and 90 of this embodiment, the fourth measurement mark 90 includes the same angular measurements as listed in Table 8.

TABLE 8

| | MRAD |
|---|---|
| A32: | 0.5 |
| A33: | 1.0 |
| A34: | 1.5 |
| A35: | 2.0 |
| A36: | 2.5 |
| A37: | 3.0 |

With particular reference to FIGS. 22 and 23, a reticle 10 of this disclosure may also comprise a fifth measurement mark 100 comprising a grid including one or more graduated marks on one or both sides of the second measurement mark 68. In an embodiment, the one or more graduated marks may be graduated in angular measurement and spaced apart in 1.0 MRAD increments, configured both (1) for accurate vertical and horizontal range estimation of targets of known dimensions using calculations known in the art of MRAD reticles, and (2) for use as precise aiming marks based on ballistic data as described above. As shown in FIG. 23, the grid may include evenly-spaced, downwardly extending MRAD marks 101 positioned to the right of the central vertical crosshair 69 in vertical alignment with vertical crosshairs 85, 87, 89 and in horizontal alignment with horizontal crosshairs 70, 72, 74, 76, 78. Correspondingly, evenly-spaced, downwardly extending MRAD marks 102 may be positioned to the left of the central vertical crosshair 69 in vertical alignment with vertical crosshairs 95, 97, 99 and in horizontal alignment with horizontal crosshairs 70, 72, 74, 76, 78. In an embodiment, the MRAD marks 101 and 102 of the fifth measurement mark 100 may include dots as shown. In an embodiment, one or more of the MRAD marks 101 and 102 may include indicia other than dots, including, but not limited to, indicia as described above. In an embodiment, the reticle 10 may further include one or more MRAD marks 101 and/or 102 not shown in FIGS. 22 and 23. In an embodiment, the reticle 10 may include fewer MRAD marks 101 and/or 102 than as shown in FIGS. 22 and 23.

With reference to FIG. 22, in an embodiment, a reticle 10 of this disclosure may also include one or more linear crosshair-type marks 105, 106, 107 (also referred to as “bars 105, 106, 107”) disposed along the outer portion of the reticle 10 (e.g., along the perimeter of the sight picture 12). As shown, the bars 105, 106, 107 may be larger or thicker in appearance than other marks of the reticle 10 to assist an operator in locating the center of the reticle 10, as larger or thicker indicia are typically easier to discern against a background through an optical medium 6 of a viewing optic 5. The length and/or thickness of each individual bar 105, 106, 107 may vary as desired, and a proximal end of each individual bar 105, 106, 107 may terminate at a distance from other indicia of the reticle 10 as desired (see proximal ends 110, 111, 112). In an embodiment, the reticle 10 may include at least a first vertical bar 105 below the ranging scale 11, with its midline in linear alignment with the first measurement mark 65 and the second measurement mark 68. The reticle 10 may also include a first horizontal bar 106 to the right of the third measurement mark 80, with its midline in linear alignment with the upper surface 84 of the horizontal crosshair 81 and the upper tip 66 of the first measurement mark 65. The reticle 10 may also include a second horizontal bar 107 to the left of the fourth measurement mark 90, with its midline in linear alignment with the upper surface 94 of the horizontal crosshair 91 and the upper tip 66 of the first measurement mark 65. In an embodiment, a reticle 10 of this disclosure may also include a second vertical bar (not shown) located above the first measurement mark 65 having a midline in linear alignment with the midline of the first vertical bar 105.

The disclosure will be better understood with reference to the following non-limiting examples, which are illustrative only and not intended to limit the present disclosure to a particular embodiment.

### Example 1

In a first non-limiting example, and with reference to FIG. 22, an operator using a reticle 10 of a viewing optic 5 on a firearm may vertically auto-range a white-tailed deer 200 at a distance of or about 400.0 yards from the reticle 10, as shown in FIG. 14. In this example, the belly 205 of the white-tailed deer 200 is aligned, or substantially aligned, with the midline 55 of the horizontal crosshair 15, and the back 210 of the white-tailed deer 200 is most closely aligned, or substantially aligned, with the uppermost edge 41 of the vertical crosshairs 21. An aiming point, or holdover, for accurately placing a shot at the white-tailed deer 200 using the reticle 10 may be determined based on the caliber of the firearm, the zeroing distance of the firearm, and the trajectory data of the projectile employed.

### Example 2

In a second non-limiting example, with reference to FIGS. 9-13, a reticle 10 comprising a ranging scale 11 as shown in FIGS. 1-4 may be provided on an optical medium 6 of a viewing optic 5 and include angular measurements as provided in Table 9.

TABLE 9

| | |
|---|---|
| A1: | between about 9.94 MOA and about 10.44 MOA |
| A2: | between about 7.39 MOA and about 7.89 MOA |
| A3: | between about 5.858 MOA and about 6.358 MOA |
| A4: | between about 4.85 MOA and about 5.35 MOA |
| A5: | between about 11.21 MOA and about 11.71 MOA |
| A6: | between about 8.35 MOA and about 8.85 MOA |
| A7: | between about 6.618 MOA and about 7.118 MOA |
| A8: | between about 5.49 MOA and about 5.99 MOA |
| A9: | between about 5.48 MOA and about 5.98 MOA |
| A10: | between about 4.05 MOA and about 4.55 MOA |
| A11: | between about 3.188 MOA and about 3.688 MOA |
| A12: | between about 2.62 MOA and about 3.12 MOA |
| A13: | between about 7.05 MOA and about 7.55 MOA |
| A14: | between about 5.01 MOA and about 5.51 MOA |
| A15: | between about 3.948 MOA and about 4.448 MOA |
| A16: | between about 3.26 MOA and about 3.76 MOA |
| A17: | between about 4.21 MOA and about 4.71 MOA |
| A18: | between about 3.09 MOA and about 3.59 MOA |
| A19: | between about 2.42 MOA and about 2.92 MOA |
| A20: | between about 1.98 MOA and about 2.48 MOA |

### Example 3

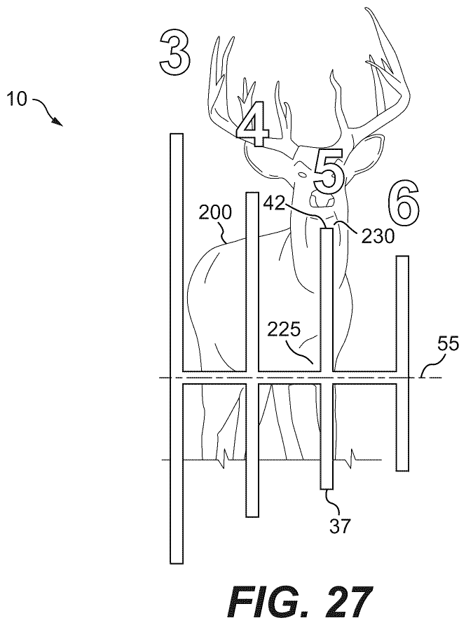

In a third non-limiting embodiment, a reticle 10 comprising a ranging scale 11 as shown in FIGS. 1-4 may be provided on an optical medium 6 of a viewing optic 5 for vertically auto-ranging a plurality of quadrupeds, each quadruped being vertically auto-ranged according to lower and upper selected anatomical target reference points corresponding to a selected vertical ranging dimension from the following: 14.0 inches, 18.0 inches, 22.0 inches, 32.0 inches, or 36.0 inches. An exemplary quadruped for vertically auto-ranging at a vertical ranging dimension of 18.0 inches includes a white-tailed deer 200 that may be vertically auto-ranged when oriented in a front facing position as shown in FIG. 27. To vertically auto-range a front facing white-tail deer 200 according to a vertical ranging dimension of 18.0 inches, a suitable lower selected anatomical target reference point is the bottom portion of the chest or brisket 225 of the white-tail deer 200, and a suitable upper selected anatomical target reference point is the upper throat 230 of the white-tail deer 200. As shown in FIG. 27, an operator may vertically auto-range a white-tailed deer 200 using the ranging scale 11 by aligning, or substantially aligning, the midline 55 of the horizontal crosshair 15 with the brisket 225 and observing which of the uppermost edges 40, 41, 42, 43 of the vertical crosshairs 20, 21, 22, 23 most closely aligns with the upper throat 230. In this example, the upper throat 230 is viewed aligned, or substantially aligned, with the uppermost edge 42 of the vertical crosshair 22, indicating that the white-tailed deer 200 is at a distance of or about 500.0 yards from the reticle 10 according to the corresponding distance numeral “5” indicium of ranging mark 18, which represents a distance of 500.0 yards in this example.

The present disclosure may be described according to one or more of the following Embodiments.

Embodiment 1. A reticle for a viewing optic, comprising:
a plurality of marks with points combinable into sets of lower and upper ranging points for auto-ranging a plurality of targets at predetermined distances from the reticle;
wherein each set of lower and upper ranging points is configured to auto-range one or more targets of the plurality of targets based on a ranging dimension using selected target reference points corresponding to the ranging dimension;
wherein at least two of the sets of lower and upper ranging points share at least one common lower ranging point; and
wherein at least two of the sets of lower and upper ranging points share at least one common upper ranging point.

Embodiment 2. The reticle of Embodiment 1, wherein lower ranging points of a first set of lower and upper ranging points are upper ranging points of a second set of lower and upper ranging points.

Embodiment 3. The reticle of Embodiment 2, wherein the lower ranging points of the first set of lower and upper ranging points are lower ranging points of a third set of lower and upper ranging points.

Embodiment 4. The reticle of Embodiment 3, wherein upper ranging points of the first set of lower and upper ranging points are upper ranging points of a fourth set of lower and upper ranging points.

Embodiment 5. The reticle of Embodiment 4, wherein upper ranging points of the third set of lower and upper ranging points are upper ranging points of a fifth set of lower and upper ranging points.

Embodiment 6. The reticle of Embodiment 5, wherein lower ranging points of the fourth set of lower and upper ranging points are lower ranging points of the fifth set of lower and upper ranging points.

Embodiment 7. The reticle of Embodiment 1, wherein the sets of lower and upper ranging points include a first set of lower and upper ranging points configured to: (1) auto-range one or more first targets of the plurality of targets according to a first set of selected target reference points for the one or more first targets based on a first ranging dimension, and (2) auto-range one or more second targets according to a second set of selected reference points for the one or more second targets based on the first ranging dimension.

Embodiment 8. The reticle of Embodiment 6, wherein each of the plurality of targets includes a first shape type and wherein the first set of lower and upper ranging points is configured to: (1) auto-range one or more first targets of the plurality of targets according to a first set of selected target reference points for the one or more first targets based on a first ranging dimension, and (2) auto-range one or more second targets according to a second set of selected reference points for the one or more second targets based on the first ranging dimension.

Embodiment 9. The reticle of Embodiment 6, wherein the first set of lower and upper ranging points is configured to auto-range a first ranging dimension of 18.0 inches, the second set of lower and upper ranging points is configured to auto-range a second ranging dimension of 14.0 inches, the third set of lower and upper ranging points is configured to auto-range a third ranging dimension of 22.0 inches, the fourth set of lower and upper ranging points is configured to auto-range a fourth ranging dimension of 32.0 inches, and the fifth set of lower and upper ranging points is configured to auto-range a fifth ranging dimension of 36.0 inches.

Embodiment 10. The reticle of Embodiment 8, wherein the first shape type corresponds to a quadruped shape type, wherein the plurality of targets include a plurality of quadrupeds, wherein the first set of selected target reference points include a first set of lower and upper selected anatomical target reference points, and wherein the second set of selected target reference points include a second set of lower and upper selected anatomical target reference points.

Embodiment 11. The reticle of Embodiment 8, wherein the first shape type corresponds to a quadruped shape type, wherein the plurality of targets include a plurality of quadrupeds, wherein the first set of selected target reference points include a first set of lower and upper selected anatomical target reference points including a lower belly reference point and an upper back reference point, and wherein the second set of selected target reference points include a second set of lower and upper selected anatomical target reference points including a lower support limb distal portion reference point and an upper back reference point.

Embodiment 12. The reticle of Embodiment 1, wherein the plurality of marks comprise at least one horizontally disposed ranging mark and a plurality of vertically disposed ranging marks, and wherein the plurality of vertically disposed ranging marks are graduated in angular measurement increments.

Embodiment 13. The reticle of Embodiment 7, wherein the first set of lower and upper ranging points is configured to auto-range the one or more second targets according to the first set of selected target reference points based on a second ranging dimension for the one or more second targets.

Embodiment 14. A reticle for a viewing optic, comprising:
a plurality of marks, including:
a first set of lower ranging points and upper ranging points defining lengths configured to auto-range a first vertical ranging dimension of one or more first targets at a plurality of predetermined distances from the reticle;
a second set of lower ranging points and upper ranging points defining lengths configured to auto-range a second vertical ranging dimension of one or more second targets at the plurality of predetermined distances from the reticle;
a third set of lower ranging points and upper ranging points defining lengths configured to auto-range a third vertical ranging dimension of one or more third targets at the plurality of predetermined distances from the reticle;
a fourth set of lower ranging points and upper ranging points defining lengths configured to auto-range a fourth vertical ranging dimension of one or more fourth targets at the plurality of predetermined distances from the reticle; and
a fifth set of lower ranging points and upper ranging points defining lengths configured to auto-range a fifth vertical ranging dimension of one or more fifth targets at the plurality of predetermined distances from the reticle;
wherein at least two of the sets of lower and upper ranging points share common lower ranging points; and
wherein at least two of the sets of lower and upper ranging points share common upper ranging points.

Embodiment 15. The reticle of Embodiment 14, wherein (a) lower ranging points of the first set are upper ranging points of the second set, (b) the lower ranging points of the first set are lower ranging points of the third set, (c) upper ranging points of the first set are upper ranging points of the fourth set, (d) upper ranging points of the third set are upper ranging points of the fifth set, and (e) lower ranging points of the fourth set are lower ranging points of the fifth set.

Embodiment 16. The reticle of Embodiment 15, wherein the second vertical ranging dimension is less than the first vertical ranging dimension and the fifth vertical ranging dimension is greater than the fourth vertical ranging dimension.

Embodiment 17. A reticle for a viewing optic, comprising:
at least one horizontally disposed ranging mark and a plurality of vertically disposed ranging marks, including:
a set of horizontally disposed first points;
a set of second points located above the first points;
a set of third points located above the first points; and
a set of fourth points located below the first points;
wherein the first points are configured as (1) lower vertical auto-ranging points for one or more first targets, (2) lower vertical auto-ranging points for one or more second targets, and (3) upper vertical auto-ranging points for one or more third targets;
wherein the second points are configured as (1) upper vertical auto-ranging points for the one or more first targets, and (2) upper vertical auto-ranging points for one or more fourth targets;
wherein the third points are configured as (1) upper vertical auto-ranging points for the one or more second targets, and (2) upper vertical auto-ranging points for one or more fifth targets;
wherein the fourth points are configured as (1) lower vertical auto-ranging points for the one or more third targets, (2) lower vertical auto-ranging points for the one or more fourth targets, and (3) lower vertical auto-ranging points for the one or more fifth targets;
wherein the lower and upper vertical auto-ranging points for the one or more first targets define a length corresponding to an angular measurement configured to auto-range a first ranging dimension;
wherein the lower and upper vertical auto-ranging points for the one or more second targets define a length corresponding to an angular measurement configured to auto-range a second ranging dimension;
wherein the lower and upper vertical auto-ranging points for the one or more third targets define a length corresponding to an angular measurement configured to auto-range a third ranging dimension;
wherein the lower and upper vertical auto-ranging points for the one or more fourth targets define a length corresponding to an angular measurement configured to auto-range a fourth ranging dimension; and wherein the lower and upper vertical auto-ranging points for the one or more fifth targets define a length corresponding to an angular measurement configured to auto-range a fifth ranging dimension.

Embodiment 18. The reticle of Embodiment 17, wherein the plurality of vertically disposed ranging marks are graduated in angular measurement increments.

Embodiment 19. A reticle for a viewing optic, comprising:
a plurality of ranging marks with points combinable into different sets of lower and upper ranging points for auto-ranging a plurality of targets at a plurality of predetermined distances from the reticle;
wherein the sets of lower and upper ranging points include a first set of lower and upper ranging points configured to: (1) auto-range one or more first targets of a first shape type according to a first set of selected target reference points for the one or more first targets based on a first ranging dimension, and (2) auto-range one or more second targets of the first shape type according to a second set of selected reference points for the one or more second targets based on the first ranging dimension.

Embodiment 20. The reticle of Embodiment 19, further comprising a second set of lower and upper ranging points configured to auto-range one or more third targets of the first shape type according to the first set of selected target reference points based on a second ranging dimension.

Embodiment 21. The reticle of Embodiment 20, further comprising a third set of lower and upper ranging points configured to auto-range one or more fourth targets of the first shape type according to the first set of selected target reference points based on a third ranging dimension, wherein the upper ranging points of the third set are the upper ranging points of the first set.

Embodiment 22. The reticle of Embodiment 21, further comprising a fourth set of lower and upper ranging points configured to auto-range one or more fifth targets of the first shape type according to the first set of selected target reference points based on a fourth ranging dimension, wherein the upper ranging points of the fourth set are the upper ranging points of the second set.

Embodiment 23. The reticle of Embodiment 22, further comprising a fifth set of lower and upper ranging points configured to auto-range one or more sixth targets of the first shape type according to the second set of selected target reference points based on a fifth ranging dimension, wherein the upper ranging points of the fifth set are the lower ranging points of the first set.

Embodiment 24. The reticle of Embodiment 23, wherein the plurality of ranging marks comprise at least one horizontally disposed ranging mark and a plurality of vertically disposed ranging marks, and wherein the lower ranging points of the first set are disposed along the horizontally disposed ranging mark.

Embodiment 25. The reticle of Embodiment 23, wherein each of the first through fifth sets of lower and upper ranging points defines lengths corresponding to angular measurements configured to auto-range a respective ranging dimension, wherein the first ranging dimension is 18.0 inches, the second ranging dimension is 22.0 inches, the third ranging dimension is 32.0 inches, the fourth ranging dimension is 36.0 inches, and the fifth ranging dimension is 14.0 inches.

Embodiment 26. The reticle of Embodiment 23, wherein the first shape type corresponds to a quadruped shape type, wherein the plurality of targets include a plurality of quadrupeds, wherein the first set of selected target reference points include a first set of lower and upper selected anatomical target reference points, and wherein the second set of selected target reference points include a second set of lower and upper selected anatomical target reference points.

Embodiment 27. The reticle of Embodiment 26, wherein the first set of lower and upper selected anatomical target reference points include a belly reference point and a back reference point, and wherein the second set of lower and upper selected anatomical target reference points include a support limb distal portion reference point and a back reference point.

Embodiment 28. The reticle of Embodiment 24, wherein the plurality of vertically disposed ranging marks are graduated in angular measurement increments.

Embodiment 29. The reticle of Embodiment 25, wherein the different sets of lower and upper ranging points are configured to auto-range the plurality of targets at distances of 300.0 yards, 400.0 yards, 500.0 yards, and 600.0 yards.

Embodiment 30. The reticle of Embodiment 1, wherein the first set of lower and upper ranging points is configured to auto-range the one or more second targets according to the first set of selected target reference points based on a sixth ranging dimension.

Embodiment 31. The reticle of Embodiment 30, wherein the sixth ranging dimension is 9.0 inches.

Embodiment 32. The reticle of Embodiment 30, wherein the first set of lower and upper ranging points are configured to auto-range the one or more second targets at distances of 150.0 yards, 200.0 yards, 250.0 yards, and 300.0 yards.

Embodiment 33. A reticle for a viewing optic, comprising:
a plurality of indicia defining angular measurements;
wherein the plurality of indicia are configured to provide vertical auto-ranging of a plurality of targets of a common shape type across a plurality of ranging dimensions at different predetermined distances; and
wherein the plurality of indicia include sets of lower and upper ranging points, wherein each set is usable to auto-range one or more targets of the plurality of targets using selected target reference points corresponding to a ranging dimension, and wherein at least some of the lower and upper ranging points are shared between two or more of the targets.

Embodiment 34. The reticle of Embodiment 33, wherein a first set of lower and upper ranging points of the plurality of sets is configured to:
(1) auto-range one or more first targets according to a first set of selected target reference points based on a first ranging dimension;
(2) auto-range one or more second targets according to a second set of selected target reference points based on the first ranging dimension; and
(3) auto-range the one or more second targets according to the first set of selected target reference points based on a second ranging dimension different from the first ranging dimension.

Embodiment 35. A reticle for a viewing optic, comprising:
one or more horizontally disposed ranging marks comprising one or more indicia and a plurality of vertically disposed ranging marks comprising one or more indicia;
wherein the one or more horizontally disposed ranging marks and the plurality of vertically disposed ranging marks define a plurality of sets of lower and upper ranging points for auto-ranging a plurality of targets at a plurality of predetermined distances from the reticle;
wherein each set of lower and upper ranging points defines a length corresponding to an angular measurement configured to auto-range one or more targets according to a vertical ranging dimension of a plurality of vertical ranging dimensions of the reticle;
wherein each set of lower and upper ranging points is configured to auto-range one or more targets using selected target reference points associated with a vertical ranging dimension of the plurality of vertical ranging dimensions; and
wherein lower and upper ranging points of at least some of the sets of lower and upper ranging points are common to two or more of the targets while being associated with different selected target reference points for the two or more targets.

Embodiment 36. The reticle of Embodiment 35, wherein a first set of lower and upper ranging points is configured to (1) auto-range one or more first quadrupeds according to a first set of selected target reference points based on a first vertical ranging dimension of the plurality of vertical ranging dimensions of the reticle, and (2) auto-range one or more second quadrupeds according to a second set of selected target reference points based on the first vertical ranging dimension.

Embodiment 37. A reticle for a viewing optic, comprising:
a first set of ranging marks configured to vertically auto-range one or more first targets of a first vertical ranging dimension at a plurality of predetermined distances from the reticle;
a second set of ranging marks configured to vertically auto-range one or more second targets of a second vertical ranging dimension at the plurality of predetermined distances from the reticle;
a third set of ranging marks configured to vertically auto-range one or more third targets of a third vertical ranging dimension at the plurality of predetermined distances from the reticle;
a fourth set of ranging marks configured to vertically auto-range one or more fourth targets of a fourth vertical ranging dimension at the plurality of predetermined distances from the reticle; and
a fifth set of ranging marks configured to vertically auto-range one or more fifth targets of a fifth vertical ranging dimension at the plurality of predetermined distances from the reticle.

Embodiment 38. The reticle of Embodiment 37, wherein:
the first set of ranging marks include a plurality of lower vertical ranging points and a plurality of upper vertical ranging points configured to vertically auto-range the one or more first targets at the plurality of predetermined distances from the reticle;
the second set of ranging marks include a plurality of lower vertical ranging points and a plurality of upper vertical ranging points configured to vertically auto-range the one or more second targets at the plurality of predetermined distances from the reticle;
the third set of ranging marks include a plurality of lower vertical ranging points and a plurality of upper vertical ranging points configured to vertically auto-range the one or more third targets at the plurality of predetermined distances from the reticle;
the fourth set of ranging marks include a plurality of lower vertical ranging points and a plurality of upper vertical ranging points configured to vertically auto-range the one or more fourth targets at the plurality of predetermined distances from the reticle; and
the fifth set of ranging marks include a plurality of lower vertical ranging points and a plurality of upper vertical ranging points configured to vertically auto-range the one or more fifth targets at the plurality of predetermined distances from the reticle.

Embodiment 39. The reticle of Embodiment 38, wherein the plurality of lower vertical ranging points of the first set of ranging marks are the plurality of lower vertical ranging points of the second set of ranging marks.

Embodiment 40. The reticle of Embodiment 38, wherein the plurality of upper vertical ranging points of the first set of ranging marks are the plurality of upper vertical ranging points of the third set of ranging marks.

Embodiment 41. The reticle of Embodiment 38, wherein the plurality of upper vertical ranging points of the second set of ranging marks are the plurality of upper vertical ranging points of the fourth set of ranging marks.

Embodiment 42. The reticle of Embodiment 38, wherein the plurality of lower vertical ranging points of the first set of ranging marks are the plurality of upper vertical ranging points of the fifth set of ranging marks.

Embodiment 43. The reticle of Embodiment 38, wherein the plurality of lower vertical ranging points of the fifth set of ranging marks are the plurality of lower vertical ranging points of the third set of ranging marks and of the fourth set of ranging marks.

Embodiment 44. The reticle of Embodiment 38 wherein (a) the plurality of lower vertical ranging points of the first set of ranging marks are the plurality of lower vertical ranging points of the second set of ranging marks, (b) the plurality of upper vertical ranging points of the first set of ranging marks are the plurality of upper vertical ranging points of the third set of ranging marks, (c) the plurality of upper vertical ranging points of the second set of vertical ranging marks are the plurality of upper vertical ranging points of the fourth set of ranging marks, (d) the plurality of lower vertical ranging points of the first set of ranging marks are the plurality of upper vertical ranging points of the fifth set of ranging marks, and (e) the plurality of lower vertical ranging points of the fifth set of ranging marks are the plurality of lower vertical ranging points of the third set of ranging marks and of the fourth set of ranging marks.

Embodiment 45. A reticle for a viewing optic, comprising:
a ranging scale including marks configured to vertically auto-range a plurality of targets at a plurality of predetermined distances from the reticle according to a selected vertical ranging dimension for each target of the plurality of targets;
wherein the marks include a first set of lower and upper vertical ranging points configured to (1) vertically auto-range one or more first targets of a first selected vertical ranging dimension according to a first set of lower and upper target points, and (2) vertically auto-range one or more second targets of the first selected vertical ranging dimension according to a second set of lower and upper target points; and
wherein the marks include at least a second set of lower and upper vertical ranging points configured to vertically auto-range one or more third targets of a second selected vertical ranging dimension according to the second set of lower and upper target points.

Embodiment 46. A reticle for a viewing optic, comprising:
a plurality of marks configured to vertically auto-range a plurality of targets at a plurality of predetermined distances from the reticle according to a selected vertical ranging dimension for each target of the plurality of targets;
wherein the plurality of marks include a first set of lower and upper vertical ranging points configured to vertically auto-range a first target of the plurality of targets according to (1) first lower and upper target points of a first selected vertical ranging dimension and (2) second lower and upper target points of the first selected vertical ranging dimension; and
wherein the plurality of marks include at least a second set of lower and upper vertical ranging points configured to vertically auto-range a second target of the plurality of targets according to the first lower and upper target points of a second selected vertical ranging dimension.

Embodiment 47. The reticle of Embodiment 46, wherein the plurality of targets include a plurality of quadrupeds and wherein the first lower and upper target points and the second lower and upper target points are lower and upper anatomical points.

Embodiment 48. A reticle for a viewing optic, comprising:
a plurality of marks including lower and upper ranging points configured to vertically auto-range a plurality of target quadrupeds at a plurality of predetermined distances from the reticle according to lower and upper anatomical points of a selected vertical ranging dimension for each target quadruped of the plurality of target quadrupeds;
wherein the lower and upper ranging points include a first lower ranging point and a first upper ranging point configured to (1) vertically auto-range a first target quadruped and a second target quadruped according to a first lower anatomical point and a first upper anatomical point and (2) vertically auto-range the second target quadruped according to a second lower anatomical point and the first upper anatomical point;
wherein the lower and upper ranging points include a second lower ranging point and a second upper ranging point configured to vertically auto-range a third quadruped according to the second lower anatomical point and the first upper anatomical point, wherein the second upper ranging point is the first lower ranging point.

Embodiment 49. The reticle of Embodiment 48, wherein the lower and upper ranging points include the first lower ranging point and a third upper ranging point configured to vertically auto-range a fourth quadruped according to the first lower anatomical point and the first upper anatomical point.

Embodiment 50. The reticle of Embodiment 49, wherein the lower and upper ranging points include the second lower ranging point and the first upper ranging point configured to vertically auto-range a fifth quadruped according to the first lower anatomical point and the first upper anatomical point.

Embodiment 51. The reticle of Embodiment 50, wherein the lower and upper ranging points include the second lower ranging point and the third upper ranging point configured to vertically auto-range a sixth quadruped according to the first lower anatomical point and the first upper anatomical point.

Embodiment 52. The reticle of Embodiment 48, wherein the first lower anatomical point is a quadruped belly and the first upper anatomical point is a quadruped back and wherein the second lower anatomical point is a quadruped lower support limb distal portion.

Embodiment 53. The reticle of Embodiment 51, wherein the first lower anatomical point is a quadruped belly and the first upper anatomical point is a quadruped back and wherein the second lower anatomical point is a quadruped lower support limb distal portion.

Embodiment 54. A reticle for a viewing optic, comprising:
a ranging scale, including:
   one or more horizontal marks; and
   a plurality of vertical marks;
wherein the one or more horizontal marks and the plurality of vertical marks are configured to vertically auto-range a plurality of targets at a plurality of predetermined distances from the reticle using points on the ranging scale to vertically auto-range each target of the plurality of targets according to a selected vertical ranging dimension for each target of the plurality of targets.

Embodiment 55. A reticle for a viewing optic, comprising at least (1) one or more horizontal marks and (2) a plurality of vertical marks; wherein the one or more horizontal marks and the plurality of vertical marks are configured to vertically auto-range a plurality of quadrupeds at a plurality of predetermined distances from the reticle using different points on the one or more horizontal marks according to anatomical lower and upper points of a selected vertical ranging dimension for each quadruped of the plurality of quadrupeds.

Embodiment 56. A reticle for a viewing optic, comprising at least indicia including one or more horizontal marks and a plurality of vertical marks; wherein the one or more horizontal marks and the plurality of vertical marks include points configured as lower and upper points to vertically auto-range a plurality of targets of selected vertical ranging dimensions at a plurality of predetermined distances from the reticle.

Embodiment 57. A reticle for a viewing optic, comprising:
at least a first horizontal mark; and
a plurality of vertical marks;
wherein the at least a first horizontal mark and the plurality of vertical marks are configured to vertically auto-range a plurality of quadruped animals belly-to-back at a plurality of selected distances from the reticle and lower support limb distal portion to back at the plurality of selected distances from the reticle.

Embodiment 58. A reticle for a viewing optic, comprising a ranging scale configured to vertically auto-range a plurality of targets based on a plurality of vertical ranging dimensions including (1) 35.56 cm (14.0 inches); (2) 45.72 cm (18.0 inches); (3) 55.88 cm (22.0 inches); (4) 81.28 cm (32.0 inches); and (5) 91.44 cm (36.0 inches).

Embodiment 59. A reticle for a viewing optic, comprising:
a ranging scale;
a central mark of the reticle; and
one or more subtension marks;
wherein the ranging scale includes:
marks configured to vertically auto-range a plurality of targets at a plurality of predetermined distances from the reticle according to selected vertical ranging dimensions;
wherein the marks include a first set of lower and upper ranging points configured to (1) auto-range one or more first targets of a first selected ranging dimension according to a first set of lower and upper selected target reference points, and (2) auto-range one or more second targets of the first selected vertical ranging dimension according to a second set of lower and upper selected target reference points; and
wherein the marks include at least a second set of lower and upper ranging points configured to auto-range one or more third targets of a second selected vertical ranging dimension according to the second set of lower and upper selected target reference points.

Embodiment 60. A method for auto-ranging one or more targets using the reticle of Embodiment 1.

Embodiment 61. A method for using the reticle of Embodiment 14.

Embodiment 62. A method for using the reticle of Embodiment 17.

Embodiment 63. A method of auto-ranging a target, comprising: aligning a reticle with the target, the reticle including marks defining sets of lower and upper ranging points; and determining a distance to the target by comparing one or more selected target reference points of the target with a set of lower and upper ranging points corresponding to a selected ranging dimension.

Embodiment 64. A method, comprising: auto-ranging a target using a reticle including marks defining sets of lower and upper ranging points, by aligning selected target reference points of the target with a first set of the lower and upper ranging points corresponding to a known ranging dimension to determine a distance to the target.

Embodiment 65. A method, comprising:
auto-ranging a target using a reticle for a viewing optic, the reticle including:
marks defining sets of lower and upper ranging points including a first set corresponding to a first ranging dimension based on selected target reference points for auto-ranging the target at predetermined distances from the reticle;
noting which lower and upper ranging points of the first set the selected target reference points most closely align with the selected target reference points to determine a distance to the target.

Although the present disclosure is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Persons of ordinary skill in the art will recognize that many modifications may be made to the present disclosure without departing from the spirit and scope of the disclosure. The embodiment(s) described herein are meant to be illustrative only and should not be taken as limiting the invention, which is defined in the claims.

I claim:

1. A reticle for a viewing optic, comprising:
a plurality of marks with points combinable into sets of lower and upper ranging points for auto-ranging a plurality of targets at predetermined distances from the reticle;
wherein each set of lower and upper ranging points is configured to auto-range one or more targets of the plurality of targets based on a ranging dimension using selected target reference points corresponding to the ranging dimension;
wherein at least two of the sets of lower and upper ranging points share at least one common lower ranging point; and
wherein at least two of the sets of lower and upper ranging points share at least one common upper ranging point.

2. The reticle of claim 1, wherein lower ranging points of a first set of lower and upper ranging points are upper ranging points of a second set of lower and upper ranging points.

3. The reticle of claim 2, wherein the lower ranging points of the first set of lower and upper ranging points are lower ranging points of a third set of lower and upper ranging points.

4. The reticle of claim 3, wherein upper ranging points of the first set of lower and upper ranging points are upper ranging points of a fourth set of lower and upper ranging points.

5. The reticle of claim 4, wherein upper ranging points of the third set of lower and upper ranging points are upper ranging points of a fifth set of lower and upper ranging points.

6. The reticle of claim 5, wherein lower ranging points of the fourth set of lower and upper ranging points are lower ranging points of the fifth set of lower and upper ranging points.

7. The reticle of claim 1, wherein the sets of lower and upper ranging points include a first set of lower and upper ranging points configured to: (1) auto-range one or more first targets of the plurality of targets according to a first set of selected target reference points for the one or more first targets based on a first ranging dimension, and (2) auto-range one or more second targets according to a second set of selected reference points for the one or more second targets based on the first ranging dimension.

8. The reticle of claim 6, wherein each of the plurality of targets includes a first shape type and wherein the first set of lower and upper ranging points is configured to: (1) auto-range one or more first targets of the plurality of targets according to a first set of selected target reference points for the one or more first targets based on a first ranging dimension, and (2) auto-range one or more second targets according to a second set of selected reference points for the one or more second targets based on the first ranging dimension.

9. The reticle of claim 6, wherein the first set of lower and upper ranging points is configured to auto-range a first ranging dimension of 18.0 inches, the second set of lower and upper ranging points is configured to auto-range a second ranging dimension of 14.0 inches, the third set of lower and upper ranging points is configured to auto-range a third ranging dimension of 22.0 inches, the fourth set of lower and upper ranging points is configured to auto-range a fourth ranging dimension of 32.0 inches, and the fifth set of lower and upper ranging points is configured to auto-range a fifth ranging dimension of 36.0 inches.

10. The reticle of claim 8, wherein the first shape type corresponds to a quadruped shape type, wherein the plurality of targets include a plurality of quadrupeds, wherein the first set of selected target reference points include a first set of lower and upper selected anatomical target reference points, and wherein the second set of selected target reference points include a second set of lower and upper selected anatomical target reference points.

11. The reticle of claim 8, wherein the first shape type corresponds to a quadruped shape type, wherein the plurality of targets include a plurality of quadrupeds, wherein the first set of selected target reference points include a first set of lower and upper selected anatomical target reference points including a lower belly reference point and an upper back reference point, and wherein the second set of selected target reference points include a second set of lower and upper selected anatomical target reference points including a lower support limb distal portion reference point and an upper back reference point.

12. The reticle of claim 1, wherein the plurality of marks comprise at least one horizontally disposed ranging mark and a plurality of vertically disposed ranging marks, and wherein the plurality of vertically disposed ranging marks are graduated in angular measurement increments.

13. The reticle of claim 7, wherein the first set of lower and upper ranging points is configured to auto-range the one or more second targets according to the first set of selected target reference points based on a second ranging dimension for the one or more second targets.

14. A reticle for a viewing optic, comprising:
a plurality of marks, including:
a first set of lower ranging points and upper ranging points defining lengths configured to auto-range a first vertical ranging dimension of one or more first targets at a plurality of predetermined distances from the reticle;
a second set of lower ranging points and upper ranging points defining lengths configured to auto-range a second vertical ranging dimension of one or more second targets at the plurality of predetermined distances from the reticle;
a third set of lower ranging points and upper ranging points defining lengths configured to auto-range a third vertical ranging dimension of one or more third targets at the plurality of predetermined distances from the reticle;
a fourth set of lower ranging points and upper ranging points defining lengths configured to auto-range a fourth vertical ranging dimension of one or more fourth targets at the plurality of predetermined distances from the reticle; and
a fifth set of lower ranging points and upper ranging points defining lengths configured to auto-range a fifth vertical ranging dimension of one or more fifth targets at the plurality of predetermined distances from the reticle;
wherein at least two of the sets of lower and upper ranging points share common lower ranging points; and
wherein at least two of the sets of lower and upper ranging points share common upper ranging points.

15. The reticle of claim 14, wherein (a) lower ranging points of the first set are upper ranging points of the second set, (b) the lower ranging points of the first set are lower ranging points of the third set, (c) upper ranging points of the first set are upper ranging points of the fourth set, (d) upper ranging points of the third set are upper ranging points of the fifth set, and (e) lower ranging points of the fourth set are lower ranging points of the fifth set.

16. The reticle of claim 15, wherein the second vertical ranging dimension is less than the first vertical ranging dimension and the fifth vertical ranging dimension is greater than the fourth vertical ranging dimension.

17. A reticle for a viewing optic, comprising:
at least one horizontally disposed ranging mark and a plurality of vertically disposed ranging marks, including:
a set of horizontally disposed first points;
a set of second points located above the first points;
a set of third points located above the first points; and
a set of fourth points located below the first points;
wherein the first points are configured as (1) lower vertical auto-ranging points for one or more first targets, (2) lower vertical auto-ranging points for one or more second targets, and (3) upper vertical auto-ranging points for one or more third targets;
wherein the second points are configured as (1) upper vertical auto-ranging points for the one or more first targets, and (2) upper vertical auto-ranging points for one or more fourth targets;
wherein the third points are configured as (1) upper vertical auto-ranging points for the one or more second targets, and (2) upper vertical auto-ranging points for one or more fifth targets;
wherein the fourth points are configured as (1) lower vertical auto-ranging points for the one or more third targets, (2) lower vertical auto-ranging points for the one or more fourth targets, and (3) lower vertical auto-ranging points for the one or more fifth targets;
wherein the lower and upper vertical auto-ranging points for the one or more first targets define a length corresponding to an angular measurement configured to auto-range a first ranging dimension;
wherein the lower and upper vertical auto-ranging points for the one or more second targets define a length corresponding to an angular measurement configured to auto-range a second ranging dimension;
wherein the lower and upper vertical auto-ranging points for the one or more third targets define a length corresponding to an angular measurement configured to auto-range a third ranging dimension;
wherein the lower and upper vertical auto-ranging points for the one or more fourth targets define a length corresponding to an angular measurement configured to auto-range a fourth ranging dimension; and
wherein the lower and upper vertical auto-ranging points for the one or more fifth targets define a length corresponding to an angular measurement configured to auto-range a fifth ranging dimension.

18. The reticle of claim 17, wherein the plurality of vertically disposed ranging marks are graduated in angular measurement increments.
